(19) United States
(12) Patent Application Publication
(10) Pub. No.: US 2025/0071810 A1
(43) Pub. Date: Feb. 27, 2025

(54) METHODS AND SYSTEMS FOR THE ALLOCATION OF ORTHOGONAL FREQUENCY DIVISION MULTIPLE ACCESS RESOURCE UNITS TO A SENSING MEASUREMENT

(71) Applicant: COGNITIVE SYSTEMS CORP., Waterloo (CA)

(72) Inventors: Chris BEG, Waterloo, Ontario (CA); Mohammad OMER, Waterloo, Ontario (CA)

(21) Appl. No.: 18/724,319

(22) PCT Filed: Dec. 9, 2022
(86) PCT No.: PCT/IB2022/062011

§ 371 Date: Jun. 28, 2024

Related U.S. Application Data
(60) Provisional application No. 63/304,957, filed on Jan. 31, 2022.
(60) Provisional application No. 63/295,630, filed on Dec. 31, 2021.

(51) Int. Cl. H04W 74/0808; H04W 72/04

(52) U.S. Cl. CPC H04W 74/0808; H04W 72/04

(57) ABSTRACT

Systems and methods for Wi-Fi sensing are provided. A method for Wi-Fi sensing carried out by a sensing device including a processor is described. Initially, a sensing goal is received. Upon receiving the sensing goal, at least one sensing transmitter and at least one sensing receiver are selected according to the sensing goal. Thereafter, an allocation of channel resources reserved for defined transmissions from the at least one sensing transmitter to the at least one sensing receiver is determined according to the sensing goal. The defined transmissions are caused from the at least one sensing transmitter to the at least one sensing receiver according to the allocation of channel resources.

### CROSS-REFERENCE TO RELATED APPLICATIONS

The present application claims benefit of U.S. Provisional Appl. No. 63/295,630, filed Dec. 31, 2021, and U.S. Provisional Appl. No. 63/304,957, filed Jan. 31, 2022, the entire contents of which are incorporated by reference herein.

### TECHNICAL FIELD

The present disclosure generally relates to methods and systems for Wi-Fi sensing. In particular, the present disclosure relates to methods and systems for allocation of orthogonal frequency division multiple access (OFDMA) resource units to sensing measurements.

### BACKGROUND OF THE DISCLOSURE

Motion detection systems have been used to detect movement, for example, of objects in a room or an outdoor area. In some example motion detection systems, infrared or optical sensors are used to detect the movement of objects in the sensor's field of view. Motion detection systems have been used in security systems, automated control systems, and other types of systems. A Wi-Fi sensing system is one recent addition to motion detection systems. The Wi-Fi sensing system may be a network of Wi-Fi-enabled devices that may be a part of an IEEE 802.11 network. For example, the Wi-Fi sensing system may include a sensing receiver and a sensing transmitter. In an example, the Wi-Fi sensing system may be configured to detect features of interest in a sensing space. The sensing space may refer to any physical space in which the Wi-Fi sensing system may operate, such as a place of residence, a place of work, a shopping mall, a sports hall or sports stadium, a garden, or any other physical space. The features of interest may include motion of objects and motion tracking, presence detection, intrusion detection, gesture recognition, fall detection, breathing rate detection, and other applications. Aspects of embodiments presented herein provide improvements to Wi-Fi sensing systems.

### BRIEF SUMMARY OF THE DISCLOSURE

The present disclosure generally relates to methods and systems for Wi-Fi sensing. In particular, the present disclosure relates to methods and systems for allocation of orthogonal frequency division multiple access (OFDMA) resource units to sensing measurements.

Systems and methods are provided for Wi-Fi sensing. In an example embodiment, a method for Wi-Fi sensing is described. The method is carried out by a sensing device including a processor configured to execute instructions. The method includes receiving, by the at least one processor, a sensing goal, selecting, by the at least one processor, at least one sensing transmitter and at least one sensing receiver according to the sensing goal, determining, by the at least one processor, an allocation of channel resources reserved for defined transmissions from the at least one sensing transmitter to the at least one sensing receiver according to the sensing goal, and causing, by the at least one processor, the defined transmissions from the at least one sensing transmitter to the at least one sensing receiver according to the allocation of channel resources.

In some embodiments, causing the defined transmissions includes causing, by the processor, transmission of a sensing trigger message to the at least one sensing transmitter to cause the defined transmissions.

In some embodiments, causing the defined transmissions includes causing, by the processor, transmission of the defined transmission by the at least one sensing transmitter.

In some embodiments, the method further includes receiving, by a sensing application, user defined sensing requirements, and translating, by the sensing application, the user defined sensing requirements into the sensing goal, wherein the processor receives the sensing goal from the sensing application.

In some embodiments, the method further includes receiving, by a sensing application, algorithmically defined sensing requirements, and translating, by a sensing application, the algorithmically defined sensing requirements into a sensing goal, wherein the processor receives the sensing goal from the sensing application.

In some embodiments, selecting the at least one sensing transmitter and the at least one sensing receiver is performed based on at least one first location of the at least one sensing transmitter and at least one second location of the at least one sensing receiver. In some embodiments, the at least one first location or the at least one second location is determined during a device registration process. In some embodiments, the at least one first location or the at least one second location is determined according to Wi-Fi transmissions.

In some embodiments, the selecting the at least one sensing transmitter and the at least one sensing receiver is performed based on a capability of the at least one sensing transmitter or the at least one sensing receiver.

In some embodiments, the selecting the at least one sensing transmitter and the at least one sensing receiver is performed based on a transmission capacity of the at least one sensing transmitter or the at least one sensing receiver.

In some embodiments, the selecting the at least one sensing transmitter and the at least one sensing receiver is performed based on a measure of success in achieving the sensing goal by a previously selected sensing transmitter and a previously selected sensing receiver.

In some embodiments, the method includes operating, by the processor and prior to selecting the at least one sensing transmitter and the at least one sensing receiver, a background detection mode, detecting, within the background detection mode, activity via Wi-Fi sensing, and transitioning to a sensing goal operating mode in response to detecting activity, wherein the sensing goal operating mode includes selecting the at least one sensing transmitter and the at least one sensing receiver and determine the allocation of channel resources.

In some embodiments, the method includes receiving, by the processor, a second sensing goal, receiving, by the at least one processor, at least one sensing result based on the defined transmissions, and responsive to the at least one sensing result, selecting a second at least one sensing transmitter and a second at least one sensing receiver according to the second sensing goal, and determining a second allocation of channel resources reserved for second defined transmissions from the second at least one sensing transmitter and the second at least one sensing receiver according to the second sensing goal.

In some embodiments, the method further includes receiving a second sensing goal, selecting a second at least one sensing transmitter and a second at least one sensing receiver according to the second sensing goal, determining a second allocation of channel resources reserved for second defined transmissions from the second at least one sensing transmitter to the second at least one sensing receiver according to the second sensing goal, and causing, by the at least one processor, both the defined transmissions and the second defined transmissions.

In some embodiments, the method further includes operating, by the processor and prior to selecting the at least one sensing transmitter and the at least one sensing receiver, a background detection mode, wherein selecting the at least one sensing transmitter and the at least one sensing receiver is performed according to sensing measurements received by the processor while operating in the background detection mode.

In some embodiments, the sensing goal is defined by at least one of target type, sensing location, detection mode, time sensitivity, and priority.

In some embodiments, the method further includes determining timing of the defined transmissions based on the sensing goal, wherein timing includes at least one of a frequency and a time-criticality.

In some embodiments, the method further includes determining a required precision of the defined transmissions based on the sensing goal.

In another example embodiment, a system for Wi-Fi sensing is described. The system includes a sensing device including at least one processor configured to execute instructions for: receiving a sensing goal; determining an allocation of channel resources reserved for defined transmissions from the at least one sensing transmitter to the at least one sensing receiver according to the sensing goal; and causing the defined transmissions from the at least one sensing transmitter to the at least one sensing receiver according to the allocation of channel resources.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system;

FIG. 2A and FIG. 2B are diagrams showing example wireless signals communicated between wireless communication devices;

FIG. 3A and FIG. 3B are plots showing examples of channel responses computed from the wireless signals communicated between wireless communication devices in FIG. 2A and FIG. 2B;

FIG. 4A and FIG. 4B are diagrams showing example channel responses associated with motion of an object in distinct regions of a space;

FIG. 4C and FIG. 4D are plots showing the example channel responses of FIG. 4A and FIG. 4B overlaid on an example channel response associated with no motion occurring in the space;

FIG. 5 depicts an implementation of some of an architecture of an implementation of a system for Wi-Fi sensing, according to some embodiments;

FIG. 6 depicts an example of a Wi-Fi network configured as a basic service set (BSS), according to some embodiments;

FIG. 7 depicts an example of a Wi-Fi network configured as an extended service set (ESS), according to some embodiments;

FIG. 8 depicts an example of a sensing application communicating a plurality of sensing goals to an access point (AP), according to some embodiments;

FIG. 9A to FIG. 9H depict a hierarchy of fields within a sensing trigger message, according to some embodiments;

FIG. 10 depicts a flowchart for causing defined transmissions from at least one sensing transmitter to at least one sensing receiver according to allocation of channel resources, according to some embodiments;

FIG. 11 depicts a flowchart for transmitting a sensing goal to a sensing device, according to some embodiments;

FIG. 12 depicts another flowchart for transmitting a sensing goal to sensing device, according to some embodiments;

FIG. 13A and FIG. 13B depict another flowchart for causing defined transmissions from at least one sensing transmitter to at least one sensing receiver according to allocation of channel resources, according to some embodiments;

FIG. 14 depicts a flowchart for transitioning of a sensing device from a background detection mode to a sensing goal operating mode in response to detecting an activity, according to some embodiments;

FIG. 15 depicts a flowchart for causing both defined transmissions and second defined transmissions from at least one sensing transmitter to at least one sensing receiver according to allocation of channel resources, according to some embodiments; and

FIG. 16 depicts a flowchart for selecting a second at least one sensing transmitter and a second at least one sensing receiver according to a second sensing goal, according to some embodiments.

### DETAILED DESCRIPTION

In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information (CSI), etc.) provided by a beamforming system. Beamforming is a signal processing technique often used in multi-antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmission rate or sensing measurement rate to produce a time-series of measurements with finer time resolution. Controlling the variable sensing measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with good signal strength. The coverage footprint of the mesh APs typically overlap, often putting each device within communication range or more than one AP. If the AP supports multi-bands (e.g., 2.4 GHz and 5 GHZ), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on the environment conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the document are provided below.

A term “measurement campaign” may refer to a bi-directional series of one or more sensing transmissions between a sensing receiver and a sensing transmitter that allows a series of one or more sensing measurements to be computed.

A term “sensing initiator” may refer to a device that initiates a Wi-Fi sensing session. The role of sensing initiator may be taken on by the sensing receiver, the sensing transmitter, or a separate device which includes a sensing algorithm (for example, a sensing device).

A term “Null Data PPDU (NDP)” may refer to a PPDU that does not include data fields. In an example, Null Data PPDU may be used for sensing transmission where it is the MAC header that includes the information required.

A term “sensing transmission” may refer to any transmission made from the sensing transmitter to the sensing receiver which may be used to make a sensing measurement. In an example, sensing transmission may also be referred to as wireless sensing signal or wireless signal.

A term “sensing trigger message” may refer to a message sent from the sensing receiver to the sensing transmitter to trigger one or more sensing transmissions that may be used for performing sensing measurements.

A term “UL-OFDMA sensing trigger message” may refer to a message from a sensing receiver to one or more sensing transmitters which causes the one or more sensing transmitters to generate a sensing transmission in a single TXOP using UL-OFDMA. The UL-OFMDA sensing trigger message include data which instructs the one or more remote devices how to form the sensing transmissions in response to the UL-OFMDA sensing trigger message. A UL-OFDMA compound sensing trigger message is a type of UL-OFDMA sensing trigger message which may cause the one or more sensing transmitters to generate a sensing transmission combined with a data transference. The UL-OFDMA compound sensing trigger message may also be called a hybrid sensing-data trigger.

A term “sensing measurement” may refer to a measurement of a state of a channel i.e., CSI measurement between the sensing transmitter and the sensing receiver derived from a sensing transmission.

A term “transmission parameters” may refer to a set of IEEE 802.11 PHY transmitter configuration parameters which are defined as part of transmission vector (TXVECTOR) corresponding to a specific PHY and which are configurable for each PHY-layer Protocol Data Unit (PPDU) transmission.

A term “PHY-layer Protocol Data Unit (PPDU)” may refer to a data unit that includes preamble and data fields. The preamble field may include the transmission vector format information and the data field may include payload and higher layer headers.

A term “sensing transmitter” may refer to a device that sends a transmission (for example, NDP and PPDUs) used for sensing measurements (for example, channel state information) in a sensing session. In an example, a station is an example of a sensing transmitter. In some examples, an access point (AP) may also be a sensing transmitter for Wi-Fi sensing purposes in the example where a station acts as a sensing receiver.

A term “sensing receiver” may refer to a device that receives a transmission (for example, NDP and PPDUs) sent by a sensing transmitter and performs one or more sensing measurements (for example, channel state information) in a sensing session. An access point (AP) is an example of a sensing receiver. In some examples, a station may also be a sensing receiver in a mesh network scenario.

A term “sensing transmission NDP” may refer to an NDP transmission which is sent by the sensing transmitter and used for a sensing measurement at the sensing receiver. The transmission follows a sensing transmission announcement and may be transmitted using transmission parameters that are defined in the sensing response announcement.

A term “channel resource” may refer to an allocation of OFDM channels which may be used to carry a modulated signal. A channel resource may include a variable number of carriers depending on the mode of the modem.

A term “sensing goal” may refer to a goal of a sensing activity at a time. A sensing goal is generated by a sensing application based on sensing requirements or may be automatically generated. A sensing goal is implemented by a sensing algorithm.

A term “sensing space” may refer to a physical space in which a Wi-Fi sensing system may operate.

A term “transmission opportunity (TXOP)” may refer to a negotiated interval of time during which a particular quality of service (QOS) station (e.g., a sensing initiator or sensing transmitter) may have the right to initiate a frame exchange onto a wireless medium. A QOS access category (AC) of the transmission opportunity may be requested as part of a negotiation.

A term “quality of service (QOS) access category (AC)” may refer to an identifier for a frame which classifies a priority of transmission that the frame requires. In an example, four QoS access categories are defined namely AC_VI: Video, AC_VO: Voice, AC_BE: Best-Effort, and AC_BK: Background. Further, each QoS access category may have differing transmission opportunity parameters defined for it.

A term “multi-user cascading sequence” may refer to a sequence of frames exchanged between a sensing receiver and one or more sensing transmitters in which the sensing receiver triggers multiple transmissions from the one or more sensing transmitters within a single TXOP.

A term “Wi-Fi sensing session” may refer to a period during which objects in a physical space may be probed, detected and/or characterized. In an example, during a Wi-Fi sensing session, several devices participate in, and thereby contribute to the generation of sensing measurements. A Wi-Fi sensing session may also be referred to as a wireless local area network (WLAN) sensing session or simply a sensing session.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a Wi-Fi sensing system configurated to send sensing transmissions and make sensing measurements.

Section C describes embodiments of methods and systems for allocation of orthogonal frequency division multiple access (OFDMA) resource units to a sensing measurement.

### A. Wireless Communications System, Wireless Transmissions, and Sensing Measurements

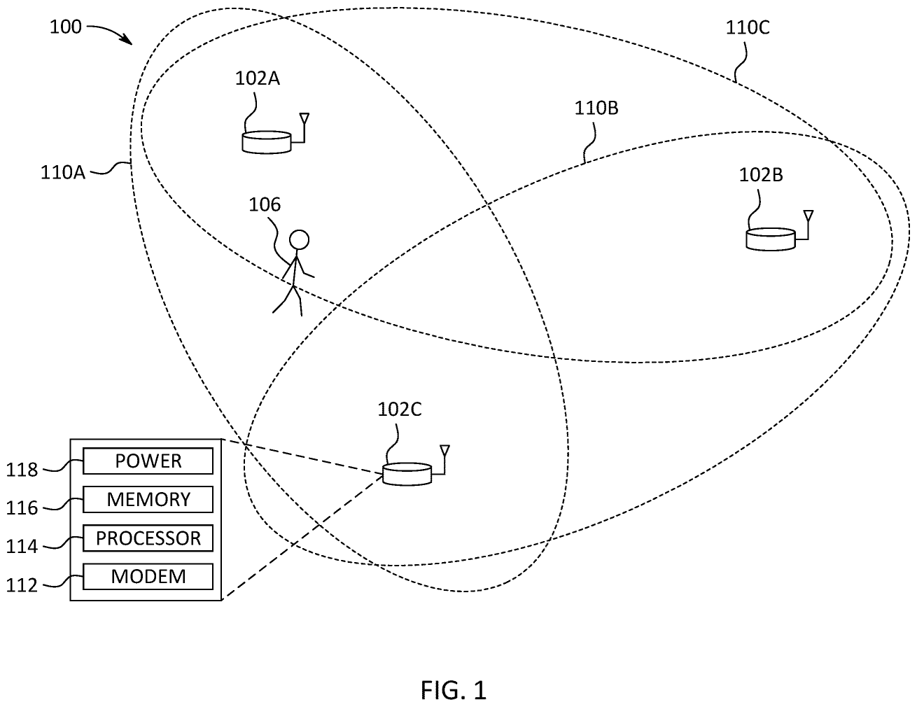

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., BLUETOOTH®, Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially available mesh network system (e.g., Plume Wi-Fi, Google Wi-Fi, Qualcomm Wi-Fi SoN, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate radio frequency (RF) signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and radio frequency circuitry. The radio frequency circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to radio frequency (RF) signals, and wirelessly transmits the radio frequency signals (e.g., through an antenna). In some instances, the radio subsystem in modem 112 wirelessly receives radio frequency signals (e.g., through an antenna), down-converts the radio frequency signals to baseband signals, and sends the baseband signals to the baseband subsystem. The signals exchanged between the radio subsystem, and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

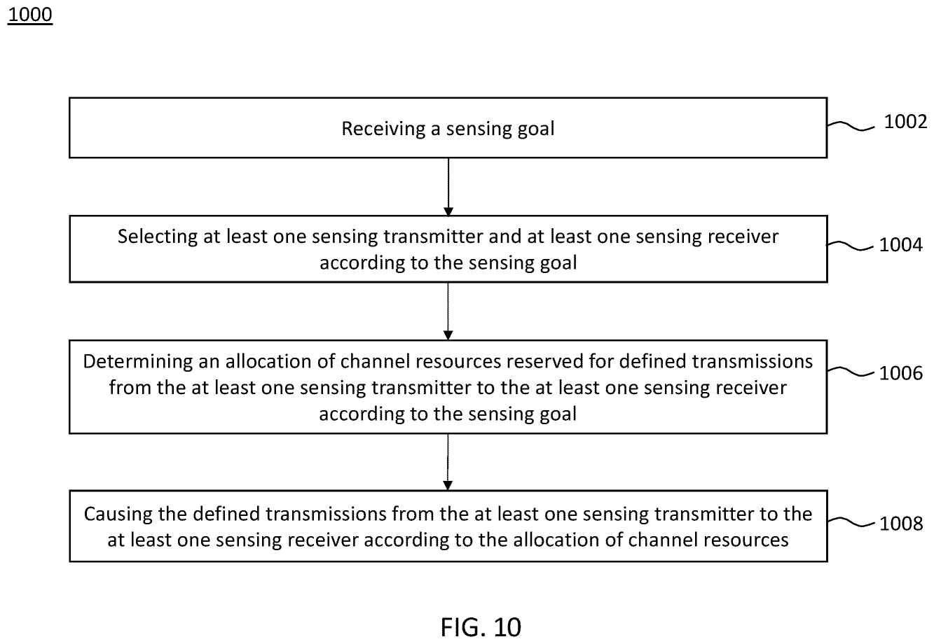

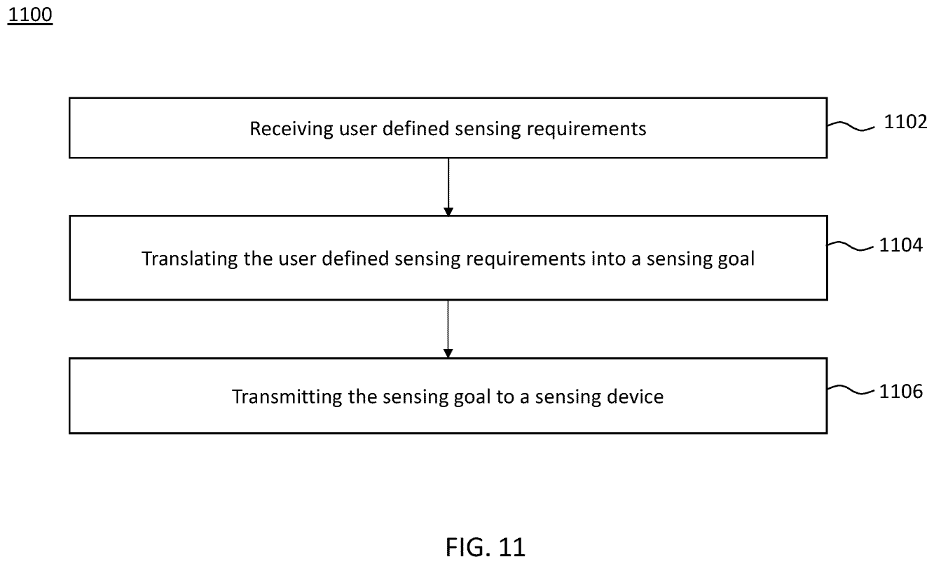

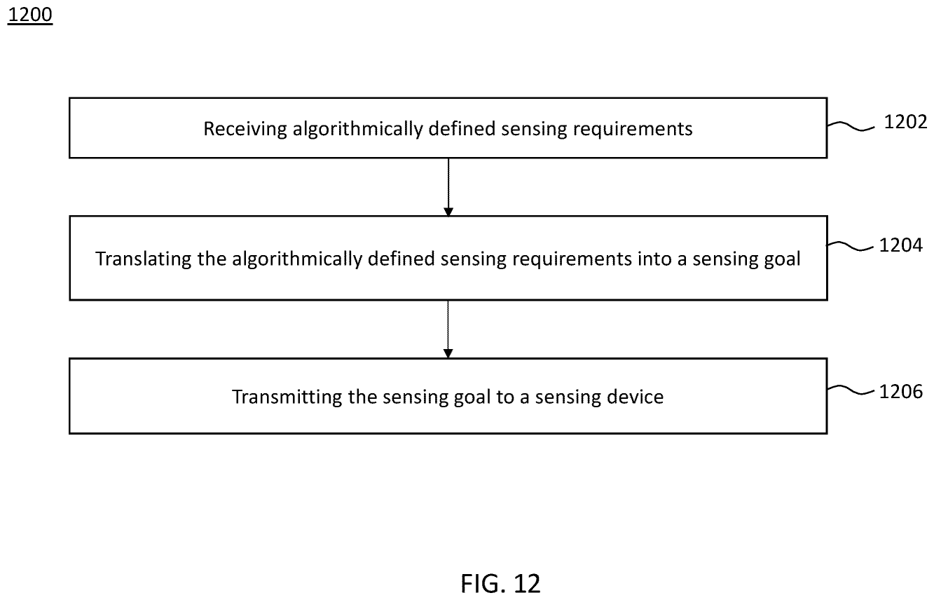

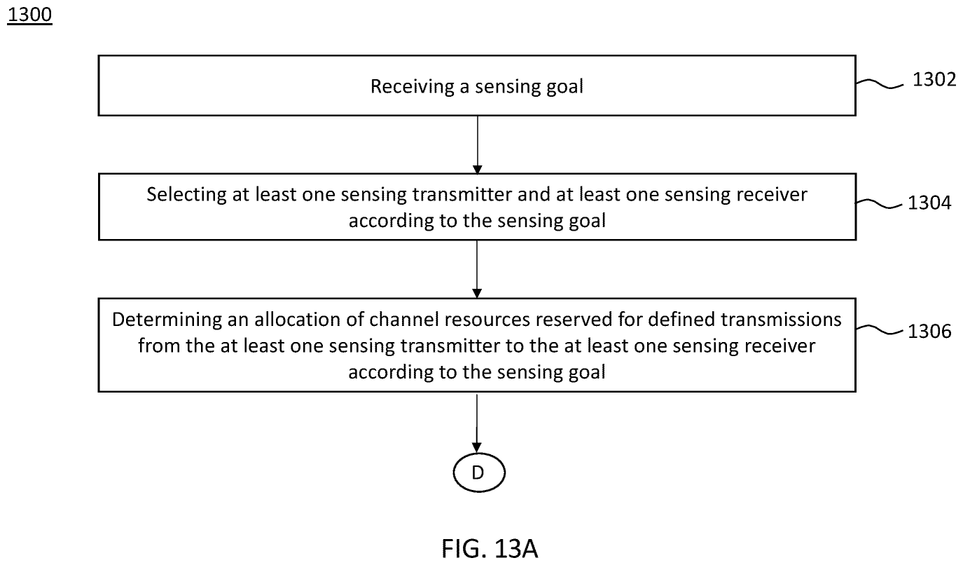

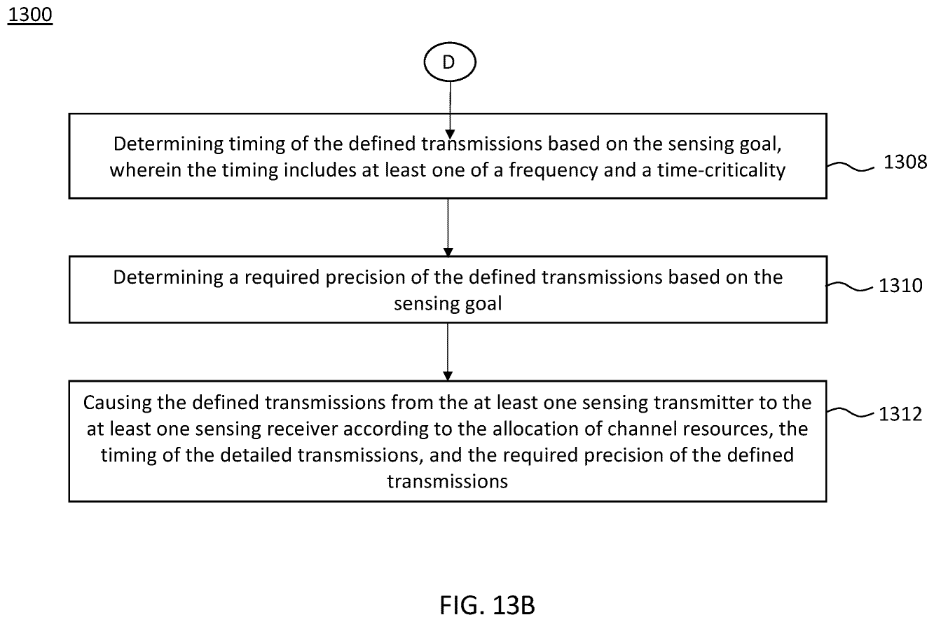

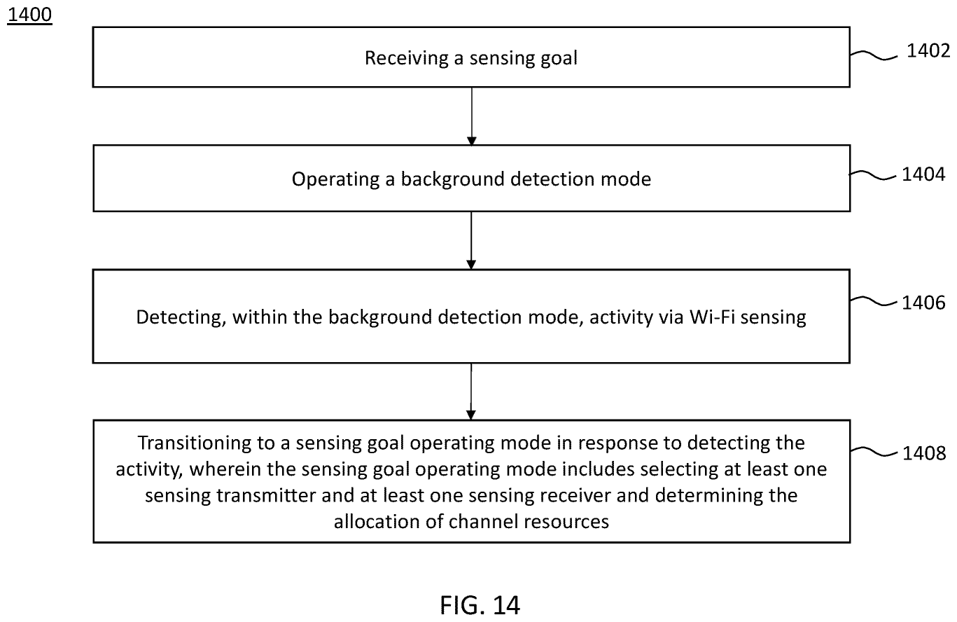

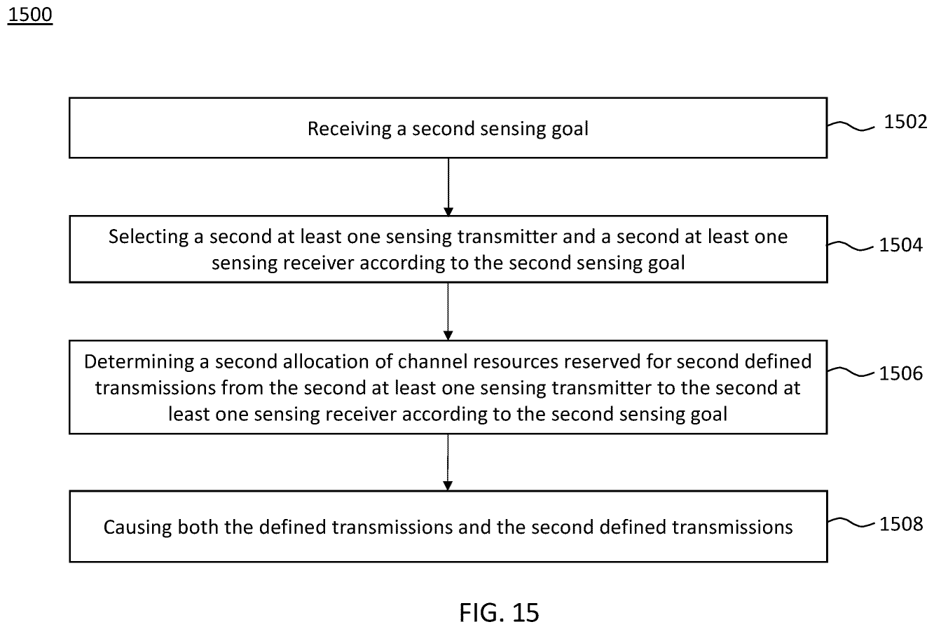

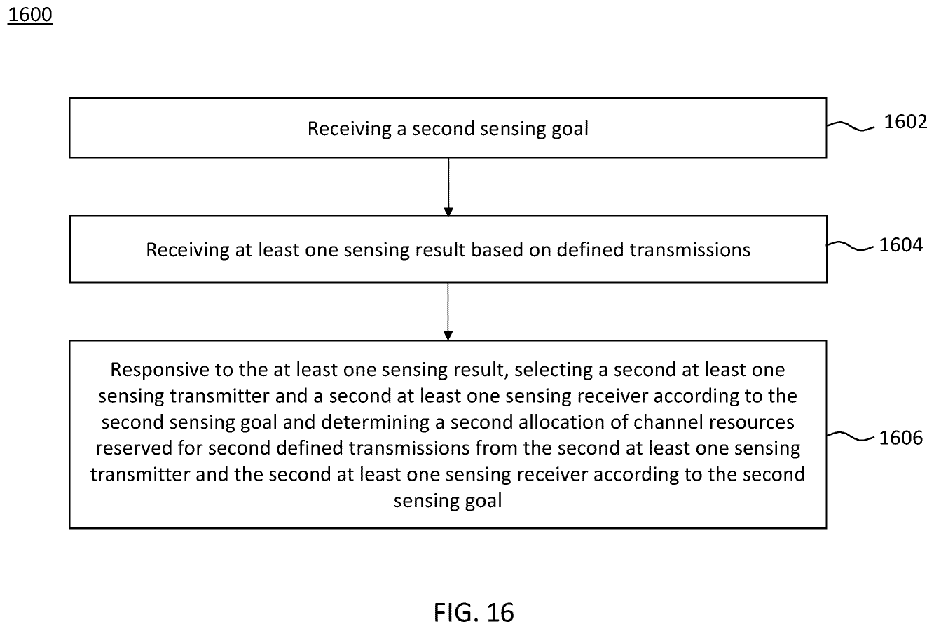

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes as described in any of FIG. 10, FIG. 11, FIG. 12, FIG. 13A, FIG. 13B, FIG. 14, FIG. 15, and FIG. 16.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current adapter or AC adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to any of FIG. 10, FIG. 11, FIG. 12, FIG. 13A, FIG. 13B, FIG. 14, FIG. 15, and FIG. 16, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in wireless communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

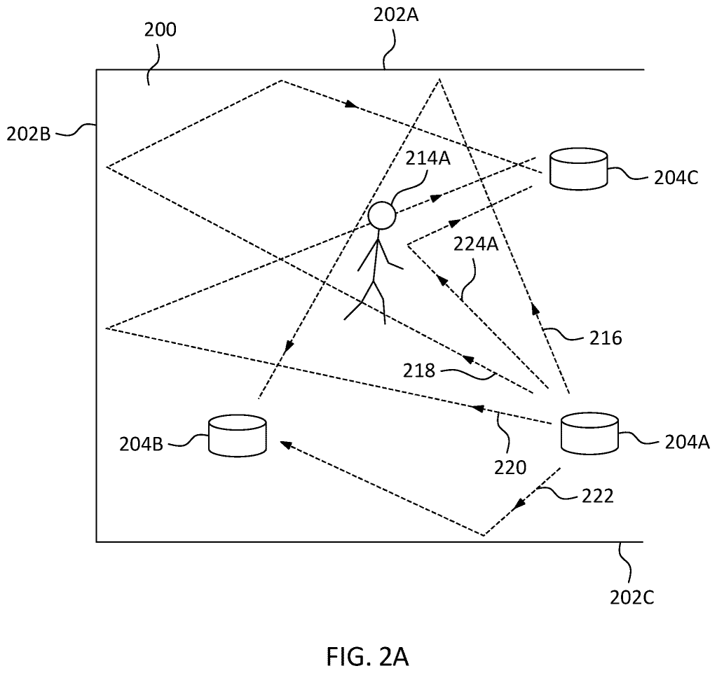

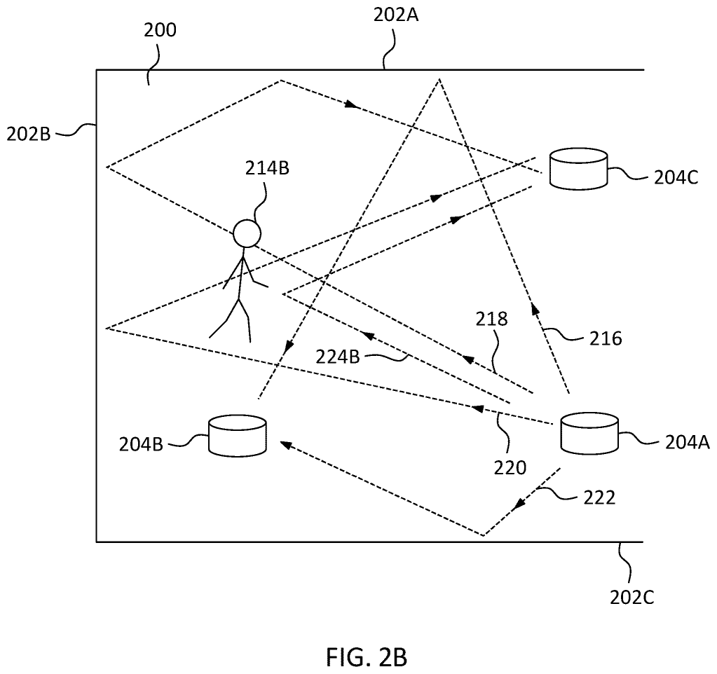

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled, or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f (t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the transmitted signal f(t) being transmitted from the first wireless communication device 204A, an output signal rₖ(t) from a path k may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where a_{n,k} represents an attenuation factor (or channel response; e.g., due to scattering, reflection, and path losses) for the nth frequency component along path k, and ϕ_{n,k} represents the phase of the signal for nth frequency component along path k. Then, the received signal R at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

The received signal R at a wireless communication device can then be analyzed. The received signal R at a wireless communication device can be transformed to the frequency domain, for example, using a Fast Fourier Transform (FFT) or another type of algorithm. The transformed signal can represent the received signal R as a series of n complex values, one for each of the respective frequency components (at the n frequencies ωₙ). For a frequency component at frequency ωₙ, a complex value Hₙ may be represented as follows in Equation (5):

$${H}_{n} = {\sum }_{k} {c}_{n} {α}_{n , k} {e}^{j {ϕ}_{n , k}} \qquad ( 5 )$$

The complex value Hₙ for a given frequency component on indicates a relative magnitude and phase offset of the received signal at that frequency component ωₙ. When an object moves in the space, the complex value Hₙ changes due to the channel response α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{c h} = {\sum }_{k} {\sum }_{n = - ∞}^{∞} {α}_{n , k} \qquad ( 6 )$$

In some instances, the channel response h_{ch} for a space can be determined, for example, based on the mathematical theory of estimation. For instance, a reference signal Ref can be modified with candidate channel responses (h_{ch}), and then a maximum likelihood approach can be used to select the candidate channel which gives a best match to the received signal (R_{cvd}). In some cases, an estimated received signal (R_{cvd}) is obtained from the convolution of the reference signal (R_{ef}) with the candidate channel responses (h_{ch}), and then the channel coefficients of the channel response (h_{ch}) are varied to minimize the squared error of the estimated received signal (R_{cvd}). This can be mathematically illustrated as follows in Equation (7):

$${R}_{cvd} = {R}_{e f} ⊗ {h}_{c h} = {\sum }_{k = - m}^{m} {R}_{e f} ( n - k ) {h}_{c h} ( k ) \qquad ( 7 )$$

with the optimization criterion

$${min}_{{h}_{c h}} \sum {( {\hat{R}}_{cvd} - {R}_{cvd} )}^{2}$$

The minimizing, or optimizing, process can utilize an adaptive filtering technique, such as Least Mean Squares (LMS), Recursive Least Squares (RLS), Batch Least Squares (BLS), etc. The channel response can be a Finite Impulse Response (FIR) filter, Infinite Impulse Response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

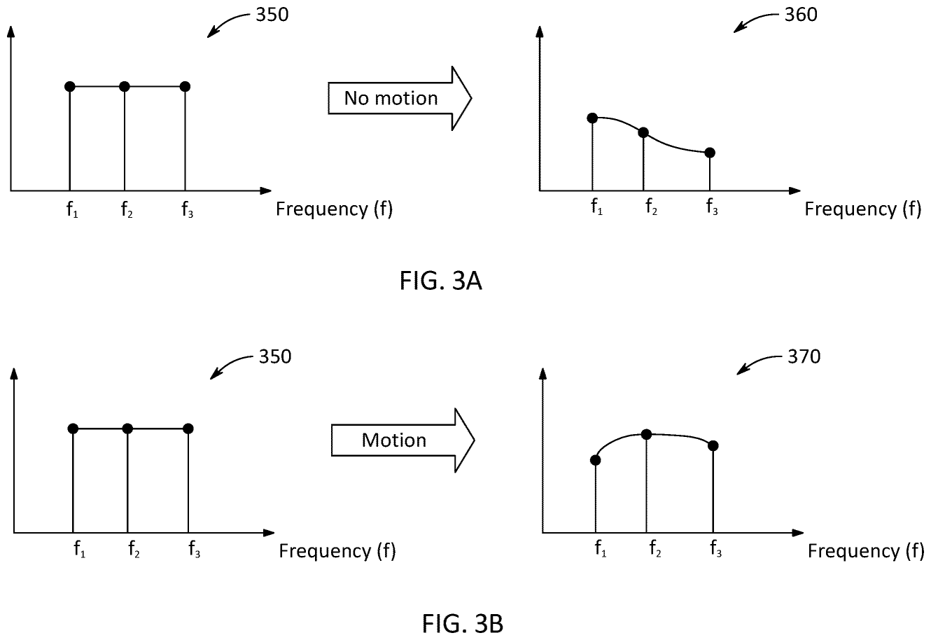

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component f₁, f₂, and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

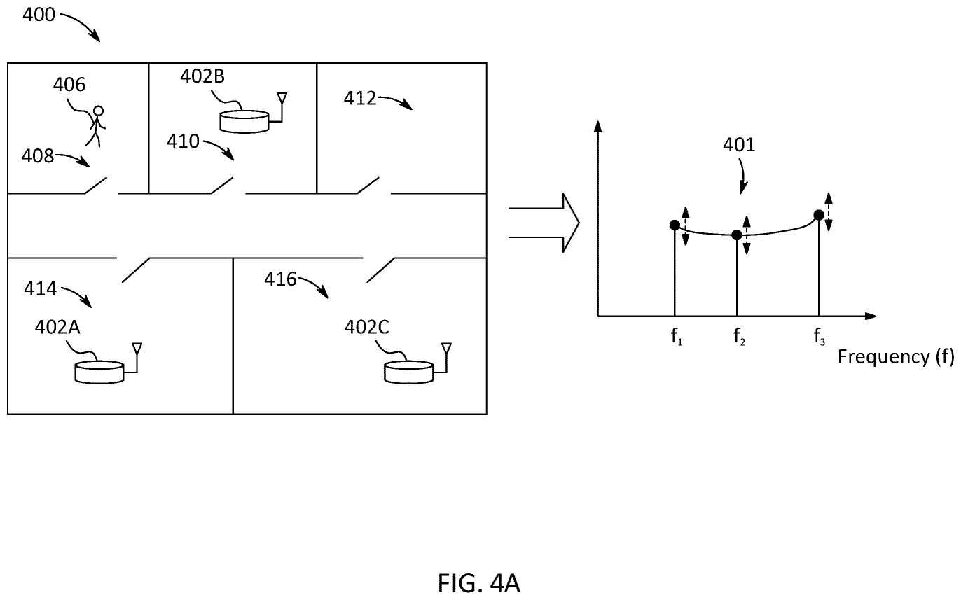

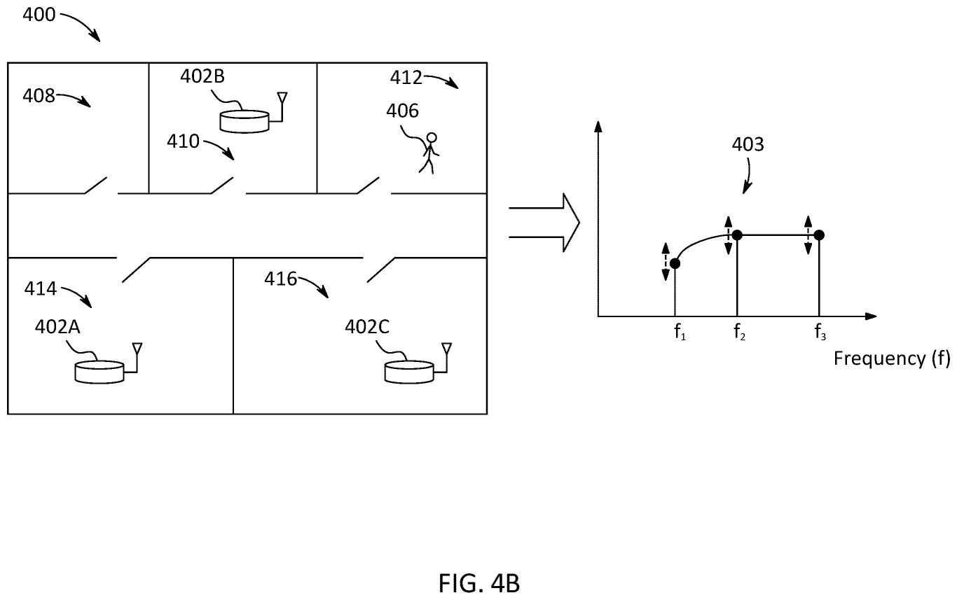

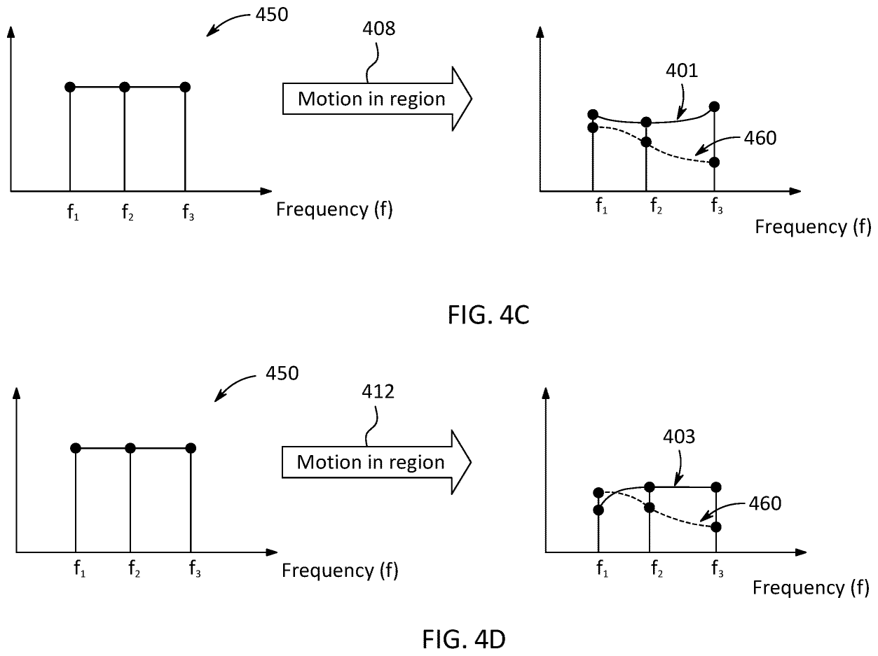

FIG. 4A and FIG. 4B are diagrams showing example channel responses 401, 403 associated with motion of object 406 in distinct regions 408, 412 of space 400 (in an example space 400 may be a sensing space). In the examples shown, space 400 is a building, and space 400 is divided into a plurality of distinct regions-first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of each frequency component f₁, f₂, and f₃. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. FIG. 4C and FIG. 4D also show frequency domain representation 450 of an initial wireless signal transmitted by one or more of wireless communication devices 402A, 402B, 402C. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence model or AI model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each frequency component f₁, f₂, and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component f₂ is less than the outer frequency components f₁ and f₃), while channel response 403 has a convex-asymptotic frequency profile (the magnitude of the middle frequency component f₂ is greater than the outer frequency components f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an artificial intelligence (AI) model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentrations of values into separate clusters, while the second layer combines some of these clusters together to create a category for a distinct region. Additionally, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a Wi-Fi sensing system configurated to send sensing transmissions and make sensing measurements.

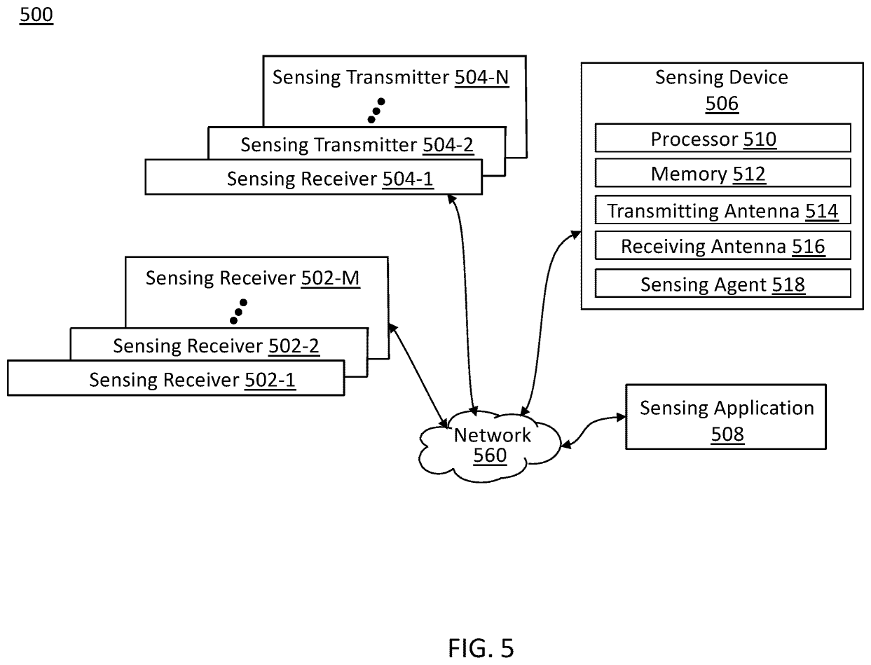

FIG. 5 depicts an implementation of some of an architecture of an implementation of system 500 for Wi-Fi sensing, according to some embodiments.

According to an implementation, system 500 may be deployed in a sensing space. In an example implementation, system 500 may be configured by a user. The user may be a professional (or a team of professionals) or a general user who oversees and manage system 500. In an example, the user may be an owner of system 500. In some example implementations, system 500 may be configured by a non-human agent. The non-human agent may be an algorithm, an artificial intelligence, or another system, for example a home security system or a health monitoring system. In an example, system 500 may be deployed in a home, and system 500 may be configured with a floor plan of the home and the floor plan may fully or partially described the sensing space. In an example, areas within the sensing space may be defined and may be described as components of the sensing space. In an implementation, system 500 may be configured to be informed of components of the sensing space.

System 500 may include plurality of sensing receivers 502-(1-M), plurality of sensing transmitters 504-(1-N), sensing device 506, sensing application 508, and network 560 enabling communication between the system components for information exchange. System 500 may be an example or instance of wireless communication system 100, and network 560 may be an example or instance of wireless network or cellular network, details of which are provided with reference to FIG. 1 and its accompanying description.

According to an embodiment, each of plurality of sensing receivers 502-(1-M) may be configured to receive a sensing transmission (for example, from each of plurality of sensing transmitters 504-(1-N)) and perform one or more measurements useful for Wi-Fi sensing. These measurements may be known as sensing measurements. The sensing measurements may be processed to achieve a sensing goal of system 500, such as detecting motions or gestures. In an embodiment, each of plurality of sensing receivers 502-(1-M) may be an AP. In some embodiments, each of plurality of sensing receivers 502-(1-M) may be a station.

According to an implementation, each of plurality of sensing receivers 502-(1-M) may be implemented by a device, such as wireless communication device 102 shown in FIG. 1. In some implementations, each of plurality of sensing receivers 502-(1-M) may be implemented by a device, such as wireless communication device 204 shown in FIG. 2A and FIG. 2B. Further, each of plurality of sensing receivers 502-(1-M) may be implemented by a device, such as wireless communication device 402 shown in FIG. 4A and FIG. 4B. In some embodiments, each of plurality of sensing receivers 502-(1-M) may be any computing device, such as a desktop computer, a laptop, a tablet computer, a mobile device, a personal digital assistant (PDA), or any other computing device. According to an implementation, each of plurality of sensing receivers 502-(1-M) may be enabled to control a measurement campaign to ensure that required sensing transmissions are made at a required time and to ensure an accurate determination of sensing measurements. In some embodiments, each of plurality of sensing receivers 502-(1-M) may process sensing measurements to achieve the sensing goal of system 500. In an example, there may be more than one sensing goal at any time and devices in system 500 (i.e., plurality of sensing receivers 502-(1-M) and plurality of sensing transmitters 504-(1-N)) may contribute to achieve the one or more sensing goals.

In some embodiments, each of plurality of sensing receivers 502-(1-M) may be configured to transmit sensing measurements to plurality of sensing transmitters 504-(1-N) or sensing device 506, and each of plurality of sensing transmitters 504-(1-N) or sensing device 506 may be configured to process the sensing measurements to achieve the sensing goal of system 500.

Referring again to FIG. 5, in some embodiments, each of plurality of sensing transmitters 504-(1-N) may form a part of a basic service set (BSS) and may be configured to send a sensing transmission to each of plurality of sensing receivers 502-(1-M) based on which one or more sensing measurements may be performed for Wi-Fi sensing. In an embodiment, each of plurality of sensing transmitters 504-(1-N) may be a station. In some embodiments, each of plurality of sensing transmitters 504-(1-N) may be an AP. According to an implementation, each of plurality of sensing transmitters 504-(1-N) may be implemented by a device, such as wireless communication device 102 shown in FIG. 1. In some implementations, each of plurality of sensing transmitters 504-(1-N) may be implemented by a device, such as wireless communication device 204 shown in FIG. 2A and FIG. 2B. Further, each of plurality of sensing transmitters 504-(1-N) may be implemented by a device, such as wireless communication device 402 shown in FIG. 4A and FIG. 4B. In some embodiments, each of plurality of sensing transmitters 504-(1-N) may be any computing device, such as a desktop computer, a laptop, a tablet computer, a mobile device, a personal digital assistant (PDA), or any other computing device. In some implementations, communication between plurality of sensing receivers 502-(1-M) and plurality of sensing transmitters 504-(1-N) may happen via station management entity (SME) and MAC layer management entity (MLME) protocols.

According to an implementation, plurality of sensing receivers 502-(1-M) and plurality of sensing transmitters 504-(1-N) may be fixed devices. In some implementations, plurality of sensing receivers 502-(1-M) and plurality of sensing transmitters 504-(1-N) may be non-fixed devices. In an implementation, system 500 may be configured with locations of plurality of sensing receivers 502-(1-M) and plurality of sensing transmitters 504-(1-N). In an example, a location may be within a component of the sensing space and may be described by reference to the component of the sensing space. In an example, system 500 may be configured with a precise location of a device (for example, a sensing receiver or a sensing transmitter). An example of the precise location may be “north-east corner of main living room”. In some examples, system 500 may be configured with an approximate location of a device. An example of the approximate location may be “upstairs landing”. In an implementation, the approximate location of the fixed or non-fixed station may be based on the AP with which the station is associated. In some implementations, a sensing algorithm on a station may be configured to report an estimation of the proximity of each AP in system 500 based on a received signal strength from each AP. In an example, a Wi-Fi probe request to each AP or a beacon frame from each AP may enable the determination by the stations of the received signal strength from each AP.

In some embodiments, sensing device 506 may be configured to receive sensing measurements from sensing receiver 502 or sensing transmitter 504 and process the sensing measurements. In an example, sensing device 506 may process and analyze sensing measurements to identify one or more features of interest. According to some implementations, sensing device 506 may include/execute a sensing algorithm. In an embodiment, sensing device 506 may be a station. In some embodiments, sensing device 506 may be an AP. According to an implementation, sensing device 506 may be implemented by a device, such as wireless communication device 102 shown in FIG. 1. In some implementations, sensing device 506 may be implemented by a device, such as wireless communication device 204 shown in FIG. 2A and FIG. 2B. Further, sensing device 506 may be implemented by a device, such as wireless communication device 402 shown in FIG. 4A and FIG. 4B. In some embodiments, sensing device 506 may be any computing device, such as a desktop computer, a laptop, a tablet computer, a mobile device, a personal digital assistant (PDA), or any other computing device. In embodiments, sensing device 506 may take a role of sensing initiator. In an embodiment, a sensing algorithm determines a measurement campaign and the sensing measurements required to fulfill the measurement campaign.

Although sensing device 506 is shown in FIG. 5 as a functional block separate from sensing receivers 502-(1-M) and sensing transmitters 504-(1-N), in an embodiment of system 500, sensing device 506 may be implemented by one of sensing receivers 502-(1-M) or by one of sensing transmitters 504-(1-N).

In some embodiments, sensing application 508 may be an application that manages and configures system 500. In an implementation, sensing application 508 may include, interface with, or execute one or more sensing algorithms. According to an implementation, sensing application 508 may configure system 500 according to requirements of the user. In some implementations, sensing application 508 may configure system 500 according to requirements of the non-human agent. According to an implementation, sensing application 508 may provide an interface between system 500 and the user via a user interface such as a Web page, a Web application, or other application. In an implementation, sensing application 508 may convert the requirements of the user and/or requirements of the non-human agent into one or more sensing goals for system 500. In some embodiments, sensing application 508 may be executed by any computing device, such as a desktop computer, a laptop, a tablet computer, a mobile device, a personal digital assistant (PDA), or any other computing device. Further, in some embodiments, sensing application 508 may take a role of sensing initiator.

Referring to FIG. 5, in more detail, sensing device 506 may include processor 510 and memory 512. For example, processor 510 and memory 512 of sensing device 506 may be processor 114 and memory 116, respectively, as shown in FIG. 1. In an embodiment, sensing device 506 may further include transmitting antenna(s) 514, receiving antenna(s) 516, and sensing agent 518. In some embodiments, an antenna may be used to both transmit and receive signals in a half-duplex format. When the antenna is transmitting, it may be referred to as transmitting antenna 514, and when the antenna is receiving, it may be referred to as receiving antenna 516. It is understood by a person of normal skill in the art that the same antenna may be transmitting antenna 514 in some instances and receiving antenna 516 in other instances. In the case of an antenna array, one or more antenna elements may be used to transmit or receive a signal, for example, in a beamforming environment. In some examples, a group of antenna elements used to transmit a composite signal may be referred to as transmitting antenna 514, and a group of antenna elements used to receive a composite signal may be referred to as receiving antenna 516. In some examples, each antenna is equipped with its own transmission and receive paths, which may be alternately switched to connect to the antenna depending on whether the antenna is operating as transmitting antenna 514 or receiving antenna 516.

In an implementation, sensing agent 518 may be responsible for receiving sensing transmissions and associated transmission parameters, calculating sensing measurements, and processing sensing measurements to fulfill a sensing goal. In some implementations, receiving sensing transmissions and associated transmission parameters, and calculating sensing measurements may be carried out by an algorithm running in the Medium Access Control (MAC) layer of sensing device 506, and processing sensing measurements to fulfill a sensing result may be carried out by an algorithm running in the application layer of sensing device 506. In some examples, the algorithm running in the application layer of sensing device 506 is known a sensing algorithm or sensing application. In some implementations, the algorithm running in the MAC layer of sensing device 506 and the algorithm running in the application layer of sensing device 506 may run separately on processor 510. In an implementation, sensing agent 518 may pass physical layer parameters (e.g., such as CSI) from the MAC layer of sensing device 506 to the application layer of sensing device 506 and may use the physical layer parameters to detect one or more features of interest. In an example, the application layer may operate on the physical layer parameters and form services or features, which may be presented to an end-user. According to an implementation, communication between the MAC layer of sensing device 506 and other layers or components may take place based on communication interfaces, such as an MLME interface and a data interface. According to some implementations, sensing agent 518 may include/execute a sensing algorithm. In an implementation, sensing agent 518 may process and analyze sensing measurements using the sensing algorithm and identify one or more features of interest. Further, sensing agent 518 may be configured to determine a number and timing of sensing transmissions and sensing measurements for the purpose of Wi-Fi sensing.

Although sensing application 508 is shown in FIG. 5 as a functional block separate from sensing device 506, in an embodiment of system 500, sensing application 508 may be implemented by sensing device 506.

### C. Methods and Systems for Allocation of Orthogonal Frequency Division Multiple Access Resource Units to a Sensing Measurement

The present disclosure generally relates to methods and systems for Wi-Fi sensing. In particular, the present disclosure relates to methods and systems for allocation of orthogonal frequency division multiple access (OFDMA) resource units to sensing measurements.

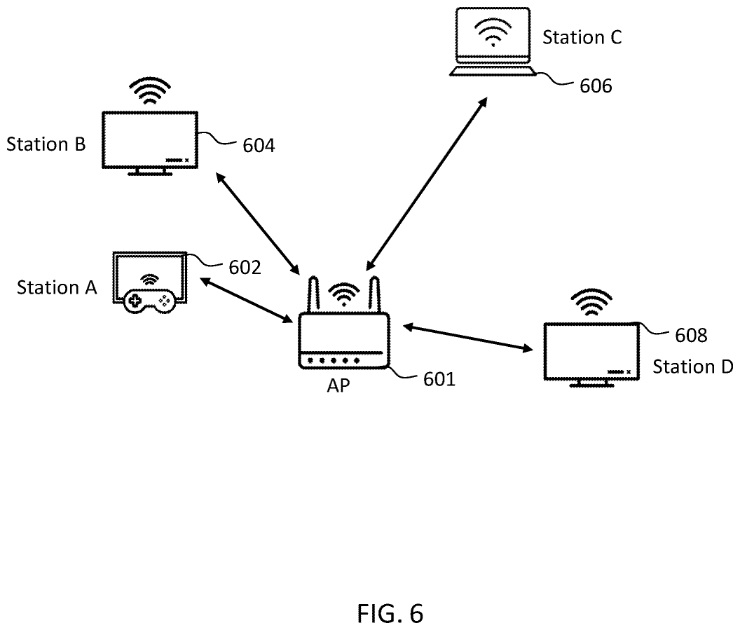

FIG. 6 depicts example 600 of a Wi-Fi network configured as a basic service set (BSS), according to some embodiments. As described in FIG. 6, the Wi-Fi network includes an AP 601 and a plurality of stations (for example, station A 602, station B 604, station C 606, and station D 608). In an embodiment of example 600, the AP may be the controlling node of the Wi-Fi network. In another embodiment of example 600, the AP may be a sensing initiator. In an example, the AP 601 may be a sensing receiver, and each station may be a sensing transmitter. In some examples, the AP 601 may be a sensing transmitter, and each station may be a sensing receiver. Further, as shown in FIG. 6, there may be a device-to-device communication between the AP 601 and each station. For example, there may be a device-to-device communication between the AP 601 and the station A 602, between the AP 601 and the station B 604, between the AP 601 and the station C 606, and between the AP 601 and the station D 608.

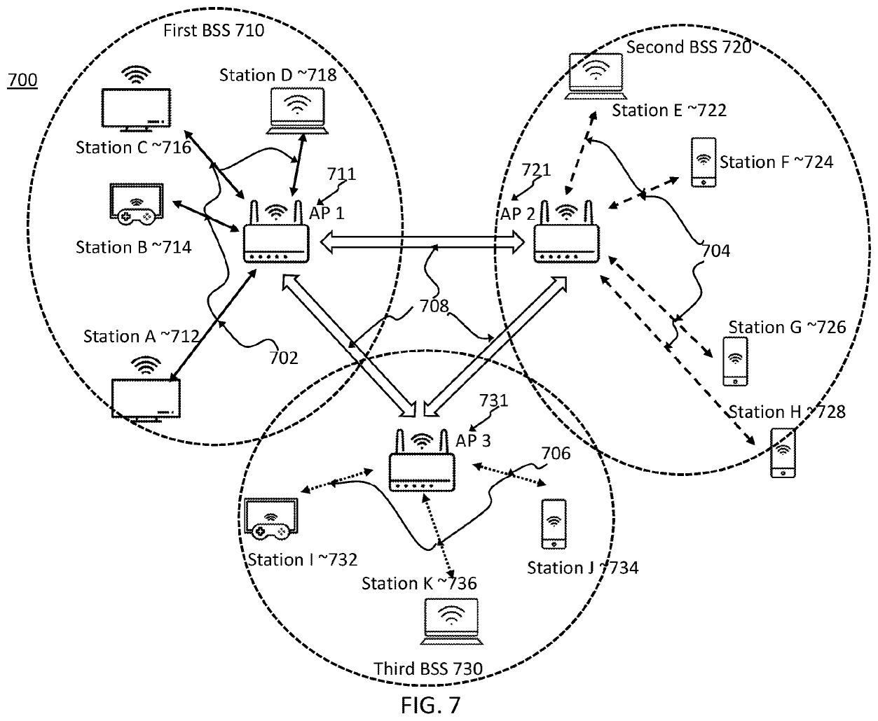

FIG. 7 depicts example 700 of a Wi-Fi network configured as an extended service set (ESS), according to some embodiments. As described in FIG. 7, the Wi-Fi network includes three BSSs, namely a first BSS 710, a second BSS 720, and a third BSS 730. In an example, each AP may form a BSS with the stations that are associated with it. The first BSS 710 includes AP 1 (711), station A 712, station B 714, station C 716, and station D 718. Each of the station A 712, the station B 714, the station C 716, and the station D 718 may be in a direct communication with the AP 1 (711) (as represented by solid line arrows, 702). The second BSS 720 includes AP 2 (721) and station E 722, station F 724, station G 726, and station H 728. Each of the station E 722, the station F 724, the station G 726, and the station H 728 may be in a direct communication with the AP 2 (721) (as represented by dash lines arrow, 704). The third BSS 730 includes AP 3 (731) and station I 732, station J 734, and station K 736. Each of the station I 732, the station J 734, and the station K 736 may be in a direct communication with the AP 3 (731) (as represented by dotted line arrows, 706). The AP 1 (711) controls the first BSS 710, the AP 2 (721), controls the second BSS 720, and the AP 3 (731) controls the third BSS 730. Further, the AP 1 (711), the AP 2 (721), and the AP 3 (731) may be in communication with each other (as represented by large arrow, 708). In an example, the communication between the AP 1 (711), the AP 2 (721), and the AP 3 (731) may be via a wired link. In some examples, the communication between the AP 1 (711), the AP 2 (721), and the AP 3 (731) may be via a wireless link. In some examples, the wireless link may be Wi-Fi in another frequency band.

Referring back to FIG. 5, according to one or more implementations, for the purpose of Wi-Fi sensing, sensing device 506 or sensing application 508 may initiate a measurement campaign (or a Wi-Fi sensing session).

In an implementation, sensing application 508 may be configured to receive user defined sensing requirements. The user defined sensing requirements may include one or more sensing requirements defined by a user. In an implementation, the user may provide the one or more sensing requirements to sensing application 508 via a user interface provided by sensing application 508. Examples of the one or more sensing requirements defined by the user may include “execute an intruder detection mode on the main floor of my home between 11 P.M. and 6 A.M., daily”, “detect an object within 3 feet of an asset”, and “detect breathing of a person in the bedroom”.

In an example, a user may interact with sensing application 508 to configure system 500 to monitor his or her breathing when the user goes to bed. Sensing application 508 may establish one or more sensing goals based on the user requirement of breathing monitoring. In some examples, a sensing goal established from a user defined sensing requirement may be to monitor the sensing space (for example, the home, or a part of the home such as one or more rooms) during the day to detect people moving about the home, and in particular movement within the user's bedroom, and entering and leaving the user's bedroom. In some examples, a sensing goal established from a user defined sensing requirement may be to monitor a specific room in the sensing space (for example, the user's bedroom) for a person entering the room and then becoming stationary in the room (without leaving the room) for a minimum period of time, which may indicate that the user has gone to bed. In an implementation, responsive to the user requirements established by the user's configuration of system 500 through sensing application 508, one or more sensing goals of system 500 may change.

In some implementations, sensing application 508 may receive algorithmically defined sensing requirements. The algorithmically defined sensing requirements may include one or more sensing requirements defined by a non-human agent, such as a home security system or a health monitoring system. Examples of the one or more sensing requirements defined by the non-human agent may include “intruder detection”, “fall detection”, and “breathing detection”. In an implementation, the non-human agent may respond to changes in system 500 or a sensing space in which system 500 is deployed to adjust, evolve, or redefine sensing requirements of system 500.

In an example implementation, the non-human agent such as the home security system may be aware when a user leaves his or her home, for example, due to an action of the user such as activation of the home alarm. Accordingly, when the user leaves his or her home, the home security system is aware that there is no one in the home. In an implementation, the home security system may interact with sensing application 508 to establish a sensing requirement of system 500 as “intrusion detection”. Further, at some later time, the user may return home and deactivate the home alarm. At that point, the home security system is aware that there is potentially someone in the home. In an example, the home security system may confirm the presence of a person in the home based on information received by motion detectors, heat detectors, or other sensors associated with the home security system. The home security system may interact with sensing application 508 to establish a sensing requirement of system 500 as “fall detection”.

According to an implementation, upon receiving the user defined sensing requirements and/or the algorithmically defined sensing requirements, sensing application 508 may be configured to translate the user defined sensing requirements and/or the algorithmically defined sensing requirements into one or more sensing goals. The one or more sensing goals may have different characteristics. According to an example, a sensing goal may have characteristics at a sensing measurement level, for example, frequency or precision. In some examples, a sensing goal may have characteristics at a sensing transmission level, for example, wide bandwidth or accurate time of transmission. In an example, a sensing goal may be dynamic and may change at any time.

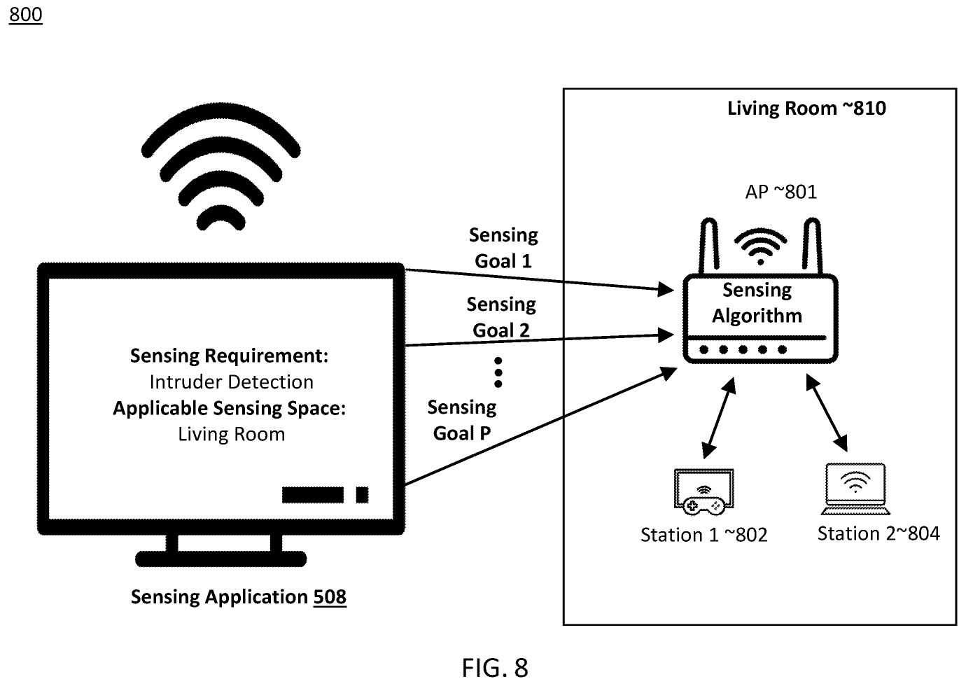

According to an implementation, after the user defined sensing requirements and/or the algorithmically defined sensing requirements are translated into the one or more sensing goals, sensing application 508 may provide the one or more sensing goals to sensing device 506. FIG. 8 depicts example 800 of sensing application 508 communicating a plurality of sensing goals to an AP 801. In an example, the AP 801 may receive the plurality of sensing goals to act as a sensing initiator. In an example, the AP 801 may be sensing device 506. In some examples, the AP 801 may be a sensing receiver (for example, any sensing receiver from among plurality of sensing receivers 502-(1-M)). In some examples, the AP 801 may be a sensing transmitter (for example, any sensing transmitter from among plurality of sensing transmitters 504-(1-N)). In an implementation, a user may input a sensing requirement as “intruder detection” and an applicable sensing space as “living room 810” via sensing application 508. Further, as described in FIG. 8, the living room 810 includes an AP 801 and two stations 802 and 804 associated with the AP 801. Upon receiving the information about the sensing requirement and the applicable sensing space, sensing application 508 may translate the sensing requirement and the applicable sensing space into a plurality of sensing goals (for example, sensing goal 1 to sensing goal P). In an example, a sensing goal may involve a determination of presence or movement in the living room. Further, sensing application 508 may send the plurality of sensing goals to the AP 801 that is located in the living room.

Referring to FIG. 5, according to an implementation, upon receiving the one or more sensing goals, sensing agent 518 may process the one or more sensing goals to identify characteristics of each of the one or more sensing goals. In an example, each sensing goal may be defined by at least one of target type, sensing location, detection mode, time sensitivity, and priority.

### A) Target Type

A sensing goal may have one or more sensing targets associated with it. A sensing target may be a discrete element that is a part of an overall set of sensing measurements. Examples a target type may be human adult, human child, large animal (for example, dog or cat), and small animal (for example, rodent). In an example, where multiple targets (potentially of different types) are present in a sensing space, a sensing goal may be associated with a sensing resolution of a target. For example, a sensing goal may be associated with a high sensing resolution of a target, where the high sensing resolution may require unique identification of one or more of the multiple targets and their movements in the sensing space. In another example, a sensing goal may be associated with a low sensing resolution of a target, where the low sensing resolution may not require unique identification of one or more of the multiple targets. In an example, a low sensing resolution of a target may be associated with a sensing goal if it is not possible to discriminate between multiple targets and uniquely identify their movements.

### B) Sensing Location

In an example, where a sensing space may be broken down into one or more component sensing spaces, a location of a sensing goal in terms of the sensing space or the one or more component sensing spaces may be identified. In an example, a house may be a sensing space and individual rooms of the house may be considered as component sensing spaces.

### C) Detection Mode

In an aspect, a mode of detection is a form of sensing operation required by a sensing goal to detect a target. Examples of modes of detection may be presence (i.e., a target is present in a sensing space), proximity (i.e., a target is within a specific distance of another object in a sensing space), motion (i.e., a target is moving in a sensing space), gesture (i.e., a target is making a gesture in a sensing space), micromovement (i.e., a target shows very small movements without any change of location), and sign of life (i.e., any movement or motion that would indicate that a target is alive).

In an implementation, speed and/or frequency associated with a mode of detection may be determined. In an example, a single instance of a presence mode of detection in a sensing space may not be sufficient to achieve a sensing goal such as counting a number of people entering a room. In the example, multiple instances of a presence mode of detection in the sensing space may be required to conclude the presence with sufficient confidence to reduce a rate of false alarms. In some examples, rapid and continuous instances of a gesture mode of detection may be required to achieve a sensing goal of detecting the target waving a hand rapidly over his or her head to indicate that assistance is required. In an implementation, the dynamics of a sensing goal may impact the mode of detection for the sensing goal. In an example, a high dynamic sensing goal may be a sensing goal that changes rapidly with time. A high dynamic sensing goal may not be achieved if sensing measurements are not made repeatedly and with high frequency.

In some implementations, the mode of detection may impact the precision of a sensing goal. A high precision sensing goal may be a sensing goal where the precision of a sensing measurement made as part of the sensing goal is especially important to the sensing goal. A high precision sensing goal may not be achieved if there is a high level of uncertainly on the sensing measurement (i.e., if the sensing measurements are of low precision). In an example, the type of precision may depend on the mode of detection of the sensing measurement to which the precision refers. For example, if the mode of detection of the sensing goal is “proximity”, then sensing measurements may be translated into a measurement of distance and the precision will be in a unit of distance, such as meters, centimeters, or millimeters. However, if the mode of detection of the sensing goal is “presence”, then the sensing measurement may be translated into a measurement of confidence of presence of the target and the precision will be in a unit of confidence, for example, percent.

### D) Time Sensitivity

A time sensitive sensing goal is a sensing goal that may be highly dependent on the timing of sensing measurements. A time sensitive sensing goal may not be achieved if one or more sensing measurements are not made at a precise and accurate moment in time.

### E) Priority

A high priority sensing goal is a sensing goal that is critical and the cost (by some measure) of not achieving the sensing goal is high.

According to an implementation, sensing agent 518 may select at least one sensing transmitter from amongst plurality of sensing transmitters 504-(1-N) and at least one sensing receiver from amongst plurality of sensing receivers 502-(1-M) according to the one or more sensing goals. In an implementation, sensing agent 518 may process the one or more sensing goals to determine the at least one sensing transmitter and the at least one sensing receiver that are to be involved in the Wi-Fi sensing session. According to an example implementation, only those sensing transmitters and sensing receivers may be selected which are able to communicate in a BSS. In another example, sensing transmitters and sensing receivers which are identified by the Wi-Fi sensing system as able to make sensing transmissions between each other may be selected.

In an implementation, sensing agent 518 may select the at least one sensing transmitter and the at least one sensing receiver based on locations of the at least one sensing transmitter and the at least one sensing receiver. In an example implementation, sensing agent 518 may select the at least one sensing transmitter and the at least one sensing receiver based on at least one first location of the at least one sensing transmitter and at least one second location of the at least one sensing receiver.

In an example, sensing agent 518 may determine the at least one first location of the at least one sensing transmitter and the at least one second location of the at least one sensing receiver during a device registration process. According to an example, a hostname or a device name of a device (for example, a sensing transmitter or a sensing receiver) may be used to determine whether the device is a fixed device or a non-fixed device. For example, a device name “Janes-PS5” of the device may imply that the device is a fixed device. Accordingly, it may be implied that the device may be located in a bedroom. In another example, a device name “Joes-iPhone” of the device may imply that the device is a non-fixed device and no location information may be determined or implied. In some examples, a location of a device may be determined during a configuration process of the device. For example, one or more questions may be provided to a user performing the configuration of the device. Based on the response received from the user, the location of the device may be determined. Further, in some examples, sensing agent 518 may determine the at least one first location of the at least one sensing transmitter and the at least one second location of the at least one sensing receiver according to Wi-Fi transmissions.

According to some implementations, sensing agent 518 may be configured to select the at least one sensing transmitter and the at least one sensing receiver based on a capability of the at least one sensing transmitter and/or the at least one sensing receiver. In an example implementation, sensing agent 518 may select the at least one sensing transmitter and the at least one sensing receiver based on the capability of the at least one sensing transmitter and/or the at least one sensing receiver. In an example, a sensing goal determined by sensing application 508 may require a mode of detection that benefits from high precision sensing measurements. In an example, sensing agent 518 may select the at least one sensing transmitter and/or the at least one sensing receiver that supports a wideband measurement to provide a high precision sensing measurement. In another example, sensing agent 518 may select the at least one sensing transmitter and/or the at least one sensing receiver that supports a sensing transmission in a higher frequency band to provide a high precision sensing measurement.

According to some implementations, sensing agent 518 may select the at least one sensing transmitter and the at least one sensing receiver based on a transmission capacity of the at least one sensing transmitter and/or a receiving capacity of the at least one sensing receiver. In an example implementation, sensing agent 518 may select the at least one sensing transmitter and the at least one sensing receiver based on the transmission capacity of the at least one sensing transmitter and/or the receiving capacity of the at least one sensing receiver.

In an example, a sensing goal determined by sensing application 508 may be to require a mode of detection that benefits from high frequency measurements. Accordingly, sensing agent 518 may select the at least one sensing transmitter and/or the at least one sensing receiver that has a high transmission or reception capacity. In an example, the transmission or the reception capacity may be determined based on a capability. For example, a wide band, high frequency channel may be assumed to have a larger transmission or reception capacity. In some examples, the transmission or reception capacity may be determined from channel occupancy information derived in real-time from plurality of sensing receivers 502-(1-M) and plurality of sensing transmitters 504-(1-N).

According to some implementations, sensing agent 518 may select the at least one sensing transmitter and the at least one sensing receiver based on a measure of success in achieving the one or more sensing goals by a previously selected sensing transmitter and a previously selected sensing receiver. In an example implementation, sensing agent 518 may perform selection of the at least one sensing transmitter and the at least one sensing receiver by implementing a feedback mechanism based on the measure of success in achieving the one or more sensing goals by the previously selected sensing transmitter and the previously selected sensing receiver. According to the feedback mechanism, a user of system 500 may be prompted to provide additional information about the one or more sensing goals, such as accuracy, timeliness, or reliability, that may aid in selection of the at least one sensing transmitter and the at least one sensing receiver.

According to an implementation, sensing agent 518 may determine defined transmissions from the selected at least one sensing transmitter and the selected at least one sensing receiver according to the one or more sensing goals. Further, sensing agent 518 may determine an allocation of channel resources reserved for the defined transmissions from the at least one sensing transmitter to the at least one sensing receiver according to the one or more sensing goals. In an implementation, sensing agent 518 may determine timing of the defined transmissions based on the one or more sensing goals. The timing includes at least one of a frequency and a time-criticality. Thereafter, sensing agent 518 may cause the defined transmissions from the at least one sensing transmitter to the at least one sensing receiver according to the allocation of channel resources.

In an implementation, sensing agent 518 may receive a second sensing goal. Further, sensing agent 518 may receive at least one sensing result based on the defined transmissions. In response to receiving the at least one sensing result, sensing agent 518 may select a second at least one sensing transmitter and a second at least one sensing receiver according to the second sensing goal. According to an implementation, sensing agent 518 may determine second defined transmissions and a second allocation of channel resources reserved for second defined transmissions from the second at least one sensing transmitter and the second at least one sensing receiver according to the second sensing goal.

In an implementation, sensing agent 518 may receive a second sensing goal. Subsequently, sensing agent 518 may select a second at least one sensing transmitter and a second at least one sensing receiver according to the second sensing goal. Sensing agent 518 may then determine a second allocation of channel resources reserved for second defined transmissions from the second at least one sensing transmitter to the second at least one sensing receiver according to the second sensing goal. Further, sensing agent 518 may cause both the defined transmissions and the second defined transmissions.

According to an implementation, sensing agent 518 may determine parameters of the defined transmissions. Examples of the parameters of the defined transmissions are provided below.

### A) Time of Transmission Opportunity (TXOP)

A TXOP is requested and secured by an AP prior to transmitting using channel resources. The time of the TXOP may be a significant criterion in initiating a sensing measurement.

### B) Duration of TXOP

The duration of a TXOP may be defined via an QoS Access Category (AC) and the duration of a TXOP associated with a sensing measurement to achieve a sensing goal may be defined by requesting a specific AC when negotiating the TXOP associated with the sensing measurement.

### C) Frequency Band

A sensing measurement may be made in a specific frequency band due to favorable propagation characteristics or favorable signal processing characteristics. In an example, a Regulatory body (e.g., IEEE) or a standard (e.g., IEEE P802.11-2020) may specify requirements or restrictions based on parameters of devices that make up system 500. In an example, channels allocated in the U-NII-5 to U-NII-8 bands (5.935 . . . 7.115 GHZ) may only be used by devices implementing the IEEE 802.11ax standard (also referred to as high-efficiency (HE) PHY). In another example, there may be regional requirements that mean that a full frequency band, even if allowed by the standard, may not be available in that region. In a further example, some frequency bands may not be available due to co-occupation with other services in a region.

### D) Channel Bandwidth

A channel bandwidth that may be used for a sensing measurement may be configurable and, in examples, may be 20 MHz, 40 MHz, 80 MHz, 160 MHz, or 320 MHz depending on the IEEE 802.11 PHY specification.

### E) Number of Subcarriers Per Channel Resource

There is flexibility in the number of subcarriers making up the channel resources within a channel used for a sensing measurement. In an example, the minimum number of subcarriers in a channel resource is 26 and the subcarrier spacing is 78.125 kHz making a minimum channel resource bandwidth for a sensing measurement of 2.03125 MHz. Examples of the manner by which channel resources of variable bandwidths may be located within a channel bandwidth are defined by IEEE 802.11.

### F) Direction of Transmission

IEEE 802.11 is a half-duplex system where a transmission may be made at a time within a bandwidth in one direction only (AP to station or station to AP). A channel may be considered to be symmetrical (i.e., it has the same propagation characteristics in both directions) and it may be considered to be asymmetrical. Depending on assumptions made concerning the symmetry of the channel, the direction of sensing transmission may be a determined parameter.

According to an implementation, sensing agent 518 may implement automatic modes of operation during Wi-Fi sensing. One example of an automatic mode of operation is a background detection mode and another example of an automatic mode of operation is a sensing goal operating mode. In an implementation, prior to selecting the at least one sensing transmitter and the at least one sensing receiver, sensing agent 518 may operate in the background detection mode. Sensing agent 518 may detect an activity within the background detection mode via Wi-Fi sensing. In an implementation, sensing agent 518 may instruct plurality of sensing transmitters 504-(1-N) and plurality of sensing receivers 502-(1-M) to perform sensing transmissions and sensing measurements, respectively in order to continuously monitor the full sensing space covered by system 500. If there is an activity of any kind within the sensing space of the system 500, sensing agent 518 may transition to the sensing goal operating mode. In an implementation, the sensing goal operating mode includes selecting the at least one sensing transmitter and the at least one sensing receiver and determining the allocation of channel resources.

According to an implementation, sensing agent 518 may not be aware of which sensing transmitters and sensing receivers and how many sensing transmitters and sensing receivers need to participate in sensing transmissions and sensing measurements to achieve the one or more sensing goals. In situations where sensing agent 518 is not aware of which sensing transmitters and sensing receivers and how many sensing transmitters and sensing receivers need to participate in sensing transmissions and sensing measurements, sensing agent 518 may first operate in the background detection mode. In the background detection mode, sensing agent 518 may determine information about plurality of sensing receivers 502-(1-M) and plurality of sensing transmitters 504-(1-N) in terms of what information sensing transmissions and sensing measurements involving plurality of sensing receivers 502-(1-M) and plurality of sensing transmitters 504-(1-N) may provide. In an example, in the background detection mode, sensing agent 518 may initiate the performing of coarse sensing measurements (for examples, low bandwidth channel resources) with plurality of sensing receivers 502-(1-M) and plurality of sensing transmitters 504-(1-N) or a subset of plurality of sensing receivers 502-(1-M) and a subset of plurality of sensing transmitters 504-(1-N). Once sensing transmitters and/or sensing receivers are identified, then sensing agent 518 may transition to sensing goal operation mode and may instruct the selected sensing transmitters and/or sensing receivers to generate increased resolution measurements (for example, higher bandwidth channel resources, higher sampling period) which align with the one or more sensing goals.

According to some implementations, sensing agent 518 may select the at least one sensing transmitter and the at least one sensing receiver according to sensing measurements received by sensing agent 518 while operating in the background detection mode.

In an implementation, sensing agent 518 may determine a frequency of the sensing measurements based on the one or more sensing goals received by sensing agent 518. In an example implementation, sensing agent 518 may use a pre-determined look up to determine the frequency of the sensing measurements according to the one or more sensing goals. For example, if a sensing goal is “motion detection”, sensing agent 518 may determine that a sensing measurement performed once every 30 seconds is sufficient to achieve the sensing goal of motion detection.

In an implementation, sensing agent 518 may determine if a sensing measurement is time-critical based on a sensing goal. This determination may be used by sensing agent 518 to determine whether the sensing measurement may be delayed or otherwise adjusted in time when optimizing the allocation of channel resources reserved for defined transmissions. In an example, a sensing requirement of detection of breathing in a hospital room may result in a time-critical sensing goal for micromovement detection. Sensing agent 518 may determine that to achieve this sensing goal, sensing transmissions and sensing measurements associated with this sensing goal may not be adjusted in time, even if this places other demands on system 500. In an example, sensing agent 518 may make a dedicated sensing transmission and/or sensing measurement for this sensing goal at the required time.

In some examples, sensing agent 518 may determine the required precision of a sensing measurement based on a sensing goal. Sensing agent 518 may also consider the resolution required to achieve the sensing goal in its determination of the required precision of a sensing measurement. In an example, if high resolution is a requirement of the sensing goal, then high precision sensing measurements may be required to achieve this sensing goal. In an example implementation, sensing agent 518 may use a look-up to associate a sensing goal to a sensing measurement precision requirement. In some example implementations, sensing agent 518 may use an iterative process where the precision requirement is determined by the outcome of a sensing algorithm in achieving the sensing goal on a previous iteration. In an example, a closed-loop process may result in the optimization of the bandwidth used for a sensing measurement to achieve the sensing goal based on a feedback mechanism and a discriminator which measures a linearized quantification of success of achieving the sensing goal. In an example implementation, sensing agent 518 may convert a required precision into a required bandwidth by algorithmic means.

According to an implementation, sensing agent 518 may cause the defined transmissions from the at least one sensing transmitter to the at least one sensing receiver according to the allocation of channel resources. In an implementation, sensing agent 518 may cause transmission of a sensing trigger message to the at least one sensing transmitter to cause the defined transmissions. In some implementations, sensing agent 518 may cause transmission of the defined transmission by the at least one sensing transmitter. In an example, the sensing trigger message may be an UL-OFDMA trigger message.

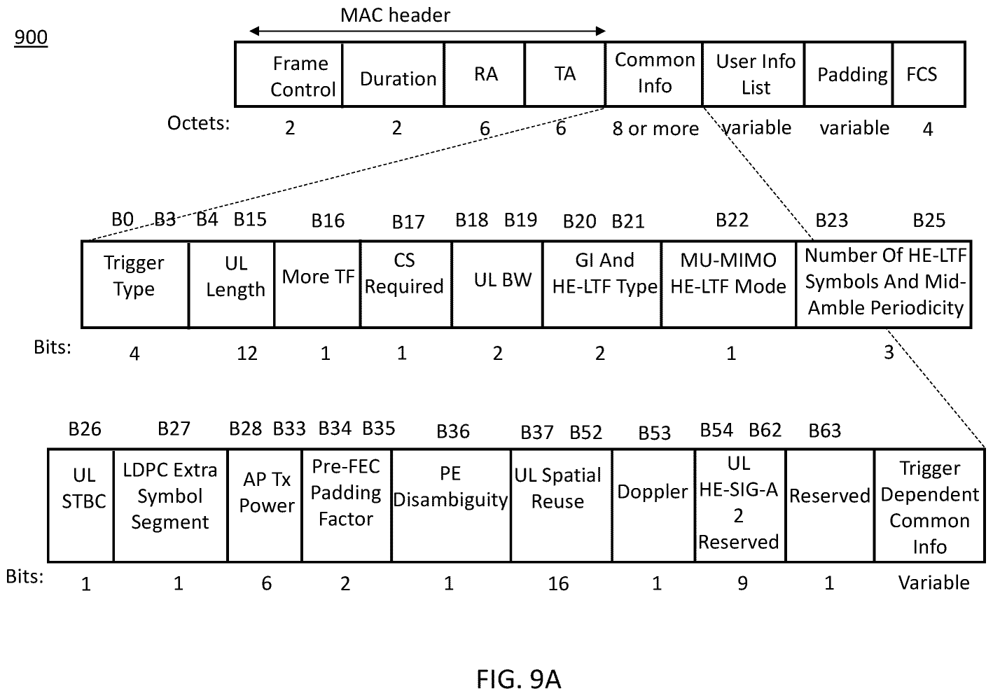

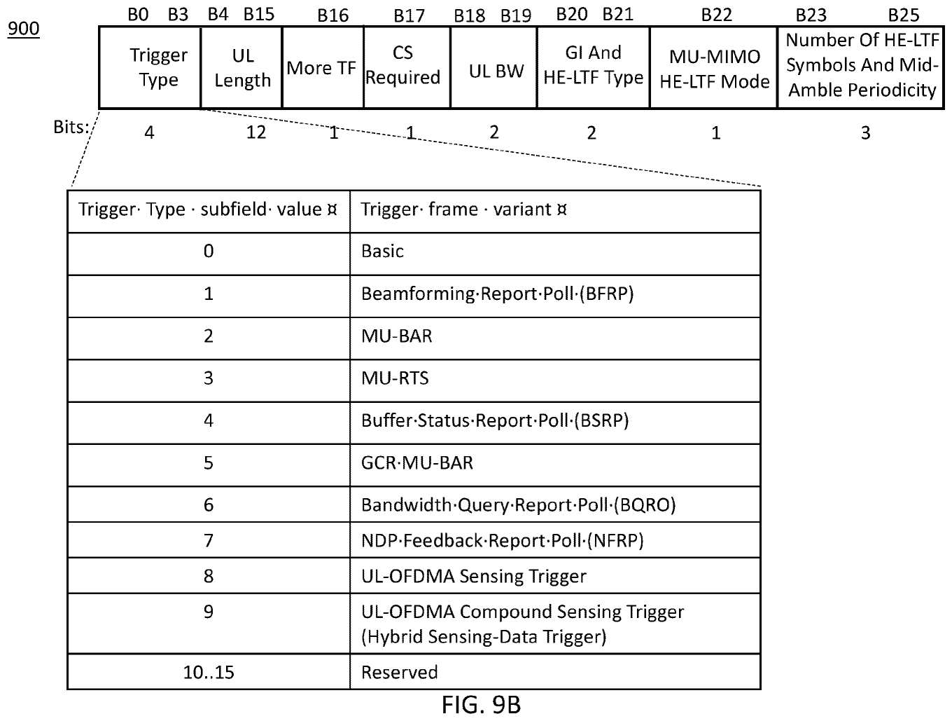

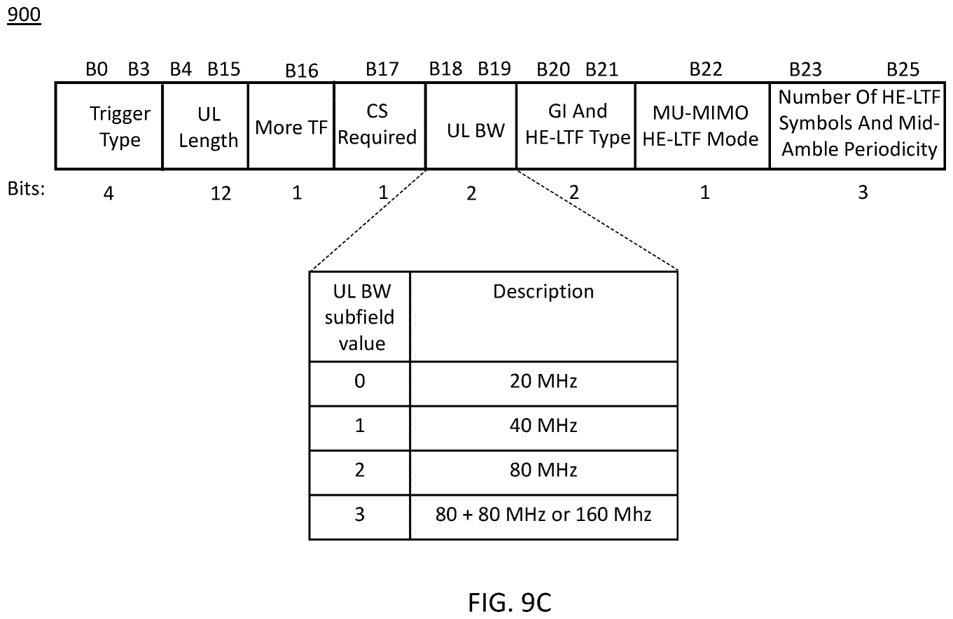

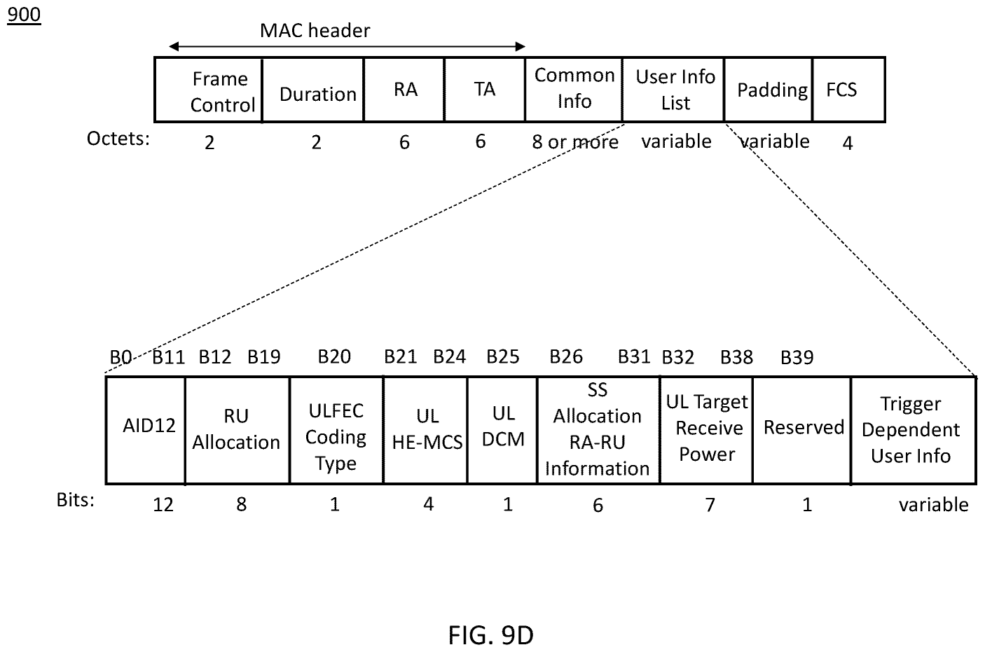

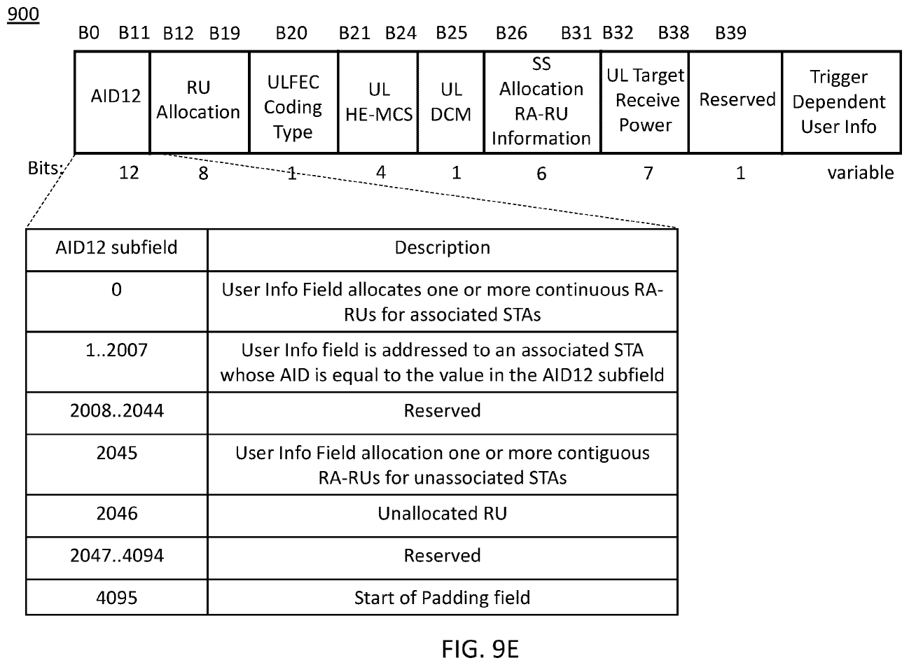

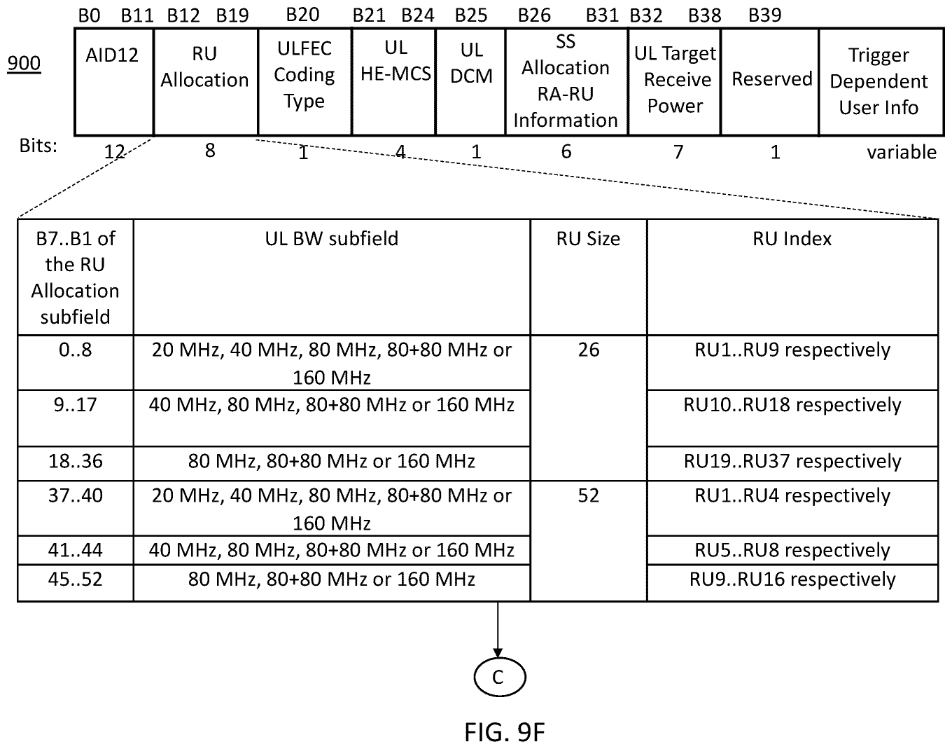

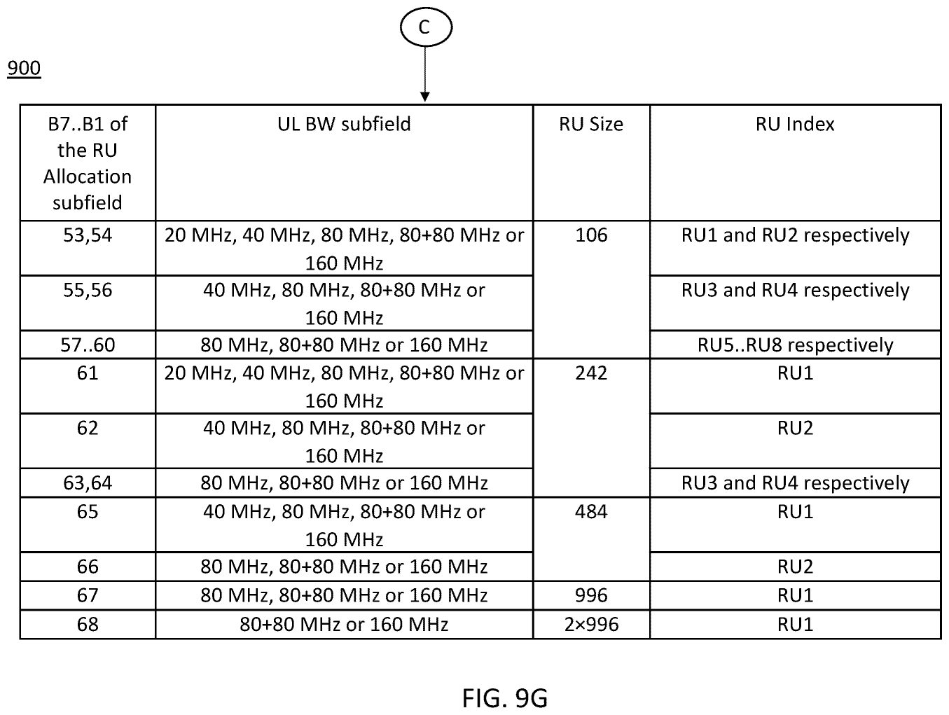

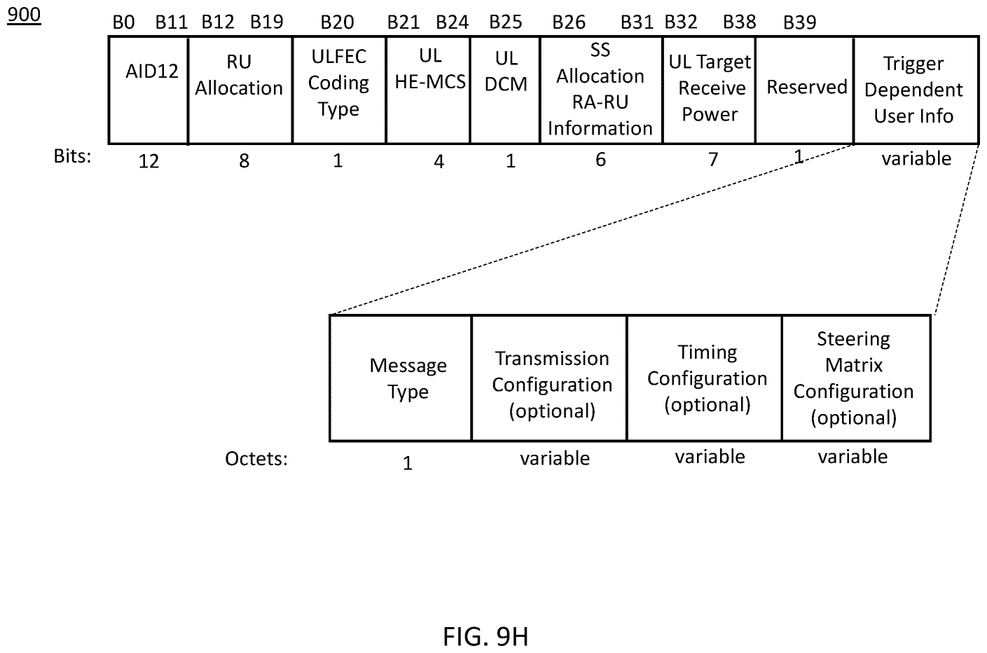

According to an implementation, example 900 of a hierarchy of fields within sensing trigger message (or UL-OFDMA sensing trigger message) is shown in FIG. 9A to FIG. 9H.

As described in FIG. 9A, the Common Info field contains information which is common to the plurality of sensing transmitters 504-(1-N). According to some implementations, the requirement of a sensing response announcement preceding a sensing response NDP may be optional. This may be indicated to sensing transmitters 504-(1-N) and may be encoded into the “Trigger Dependent Common Info” field if the requirement is common to all responding sensing transmitters, or into the “Trigger Dependent User Info” field if the requirement is specific to one or more responding sensing transmitters. According to an example, the requirement for a sensing announcement preceding a sensing response NDP may be encoded by a single bit where 0 (bit clear) indicates that a sensing announcement is optional and 1 (bit set) indicates that a sensing announcement is required.

As described in FIG. 9B, a Trigger Type (within B0 . . . 3 of “Common Info” field) may be defined which represents the sensing trigger message. An UL-OFDMA Sensing Trigger message may have a Trigger Type subfield value of 8 and an UL-OFDMA Compound Sensing Trigger message may have a Trigger Type subfield value of 9. In an example of triggering a sensing transmission from a sensing transmitter, “Trigger Dependent User Info” field may include sensing trigger message data. In an implementation, a time-synchronized sensing transmission may be required from all sensing transmitters responding to the compound sensing trigger message. In an example, the requirement for a time-synchronized sensing transmission may be encoded into “Trigger Dependent Common Info” field. According to an example, the requirement may be encoded by a single bit where 0 (bit clear) represents a request for a normal or non-time-synchronized response and 1 (bit set) represents a request for a time-synchronized response. In some examples, a method of time-synchronization may be requested in the UL-OFDMA Sensing Trigger or the UL-OFDMA Compound Sensing Trigger. In examples, the method of time-synchronization to be requested may be encoded into a “Trigger Dependent Common Info” field. In examples the encoding may use two bits as shown in the following table.

| Encoding | Method | Description |
|---|---|---|
| 0 | A | Sensing response announcement followed by sensing response NDP. |
| 1 | B | Padding followed by a sensing response message. |
| 10 | C | Sensing response NDP without an initial sensing response |
| | | announcement. |
| 11 | N/A | For future use or extensions. |

As described in FIG. 9C the compound sensing trigger message may have an uplink bandwidth (UL BW) subfield value of 0, 1, 2 or 3 corresponding to bandwidths of 20 MHz, 40 MHz, 80 MHz, or 80+80 MHz (160 MHz).

As described in FIG. 9D, the User Info List contains information which is specific to each of the plurality of sensing transmitters 504-(1-N).

As described in FIG. 9E, the AID12 subfield may be used to address a specific sensing transmitter of the plurality of sensing transmitters 504-(1-N).

As described in FIG. 9F and FIG. 9G, the RU Allocation subfield is used to allocate resource units (RU) to each of the plurality of sensing transmitters 504-(1-N).

As described in FIG. 9H, the Trigger Dependent User Info subfield may be used to request the transmission configuration and/or steering matrix configuration for each of the plurality of sensing transmitters 504-(1-N) that the sensing trigger message is triggering.

According to an example implementation, when the time requirements and bandwidth requirements for each device in system 500 has been determined, sensing agent 518 may determine the minimum channel resources required at a given time to achieve a sensing goal. Where there are multiple concurrent sensing goals, sensing agent 518 may attempt to deliver the sensing goals in parallel. In an example, where there is insufficient bandwidth to deliver all concurrent sensing goals in parallel, then sensing agent 518 may attempt to achieve the sensing goals in a sequential round-robin manner. In an example, sensing agent 518 may attempt to achieve the one or more concurrent sensing goals according to the priority of the sensing goals. In some examples, sensing agent 518 may attempt to achieve the one or more concurrent sensing goals according to the time sensitivity of the sensing goals.

According to an implementation, to achieve a sensing goal, a long TXOP may be used and multiple sensing transmissions are delivered in the same TXOP using multi-user cascading sequence. In an implementation, sensing agent 518 may use a bandwidth packing algorithm. In an example, the bandwidth packing algorithm may be designed to pack the channel resources requests into the long TXOP in an optimized way. In an example implementation, the bandwidth packing algorithm may be pre-configured with packing rules that relate to channel resources packing limitations defined by a specification, such as IEEE 802.11ax. In an example, when the channel resources allocation per TXOP has been determined, sensing agent 518 may secure a TXOP for a first sensing transmission. Further, sensing agent 516 may generate either a OFDMA frame (for example, downlink OFDMA) or a downlink frame to trigger an OFDMA transmission from the sensing transmitters to the sensing receivers (for example, uplink OFDMA). In an example, the downlink frame may include sensing NDP announcements followed after SIFS by a sensing NDPs to each of the sensing receivers identified during the previous processing. In an example, the uplink frame may be a Trigger frame. In another example, the uplink frame may be an UL-OFDMA sensing trigger message. If a periodic sensing measurement is required, sensing agent 518 may subsequently secure TXOPs on a periodic basis and make repeated downlink sensing transmissions or sensing triggers for uplink sensing transmissions.

FIG. 10 depicts flowchart 1000 for causing defined transmissions from at least one sensing transmitter to at least one sensing receiver according to allocation of channel resources, according to some embodiments.

In a brief overview of an implementation of flowchart 1000, at step 1002, a sensing goal is received. At step 1004, at least one sensing transmitter and at least one sensing receiver are selected according to the sensing goal. At step 1006, an allocation of channel resources reserved for defined transmissions from the at least one sensing transmitter to the at least one sensing receiver are determined according to the sensing goal. At step 1008, the defined transmissions are caused from the at least one sensing transmitter to the at least one sensing receiver according to the allocation of channel resources.

Step 1002 includes receiving a sensing goal. According to an implementation, sensing agent 518 on sensing device 506 may be configured to receive the sensing goal. In an implementation, the sensing goal is defined by at least one of target type, sensing location, detection mode, time sensitivity, and priority.

Step 1004 includes selecting at least one sensing transmitter and at least one sensing receiver according to the sensing goal. According to an implementation, sensing agent 518 on sensing device 506 may be configured to select the at least one sensing transmitter and the at least one sensing receiver according to the sensing goal. In an implementation, sensing agent 518 on sensing device 506 may select the at least one sensing transmitter and the at least one sensing receiver based on a capability of the at least one sensing transmitter or the at least one sensing receiver. In an implementation, sensing agent 518 on sensing device 506 may select the at least one sensing transmitter and the at least one sensing receiver based on a transmission capacity of the at least one sensing transmitter or the at least one sensing receiver. In an implementation, sensing agent 518 on sensing device 506 may select the at least one sensing transmitter and the at least one sensing receiver based on a measure of success in achieving the sensing goal by a previously selected sensing transmitter and a previously selected sensing receiver. In an implementation, sensing agent 518 on sensing device 506 may select the at least one sensing transmitter and the at least one sensing receiver based on at least one first location of the at least one sensing transmitter and at least one second location of the at least one sensing receiver. In an implementation, the at least one first location or the at least one second location is determined during a device registration process. In an implementation, the at least one first location or the at least one second location is determined according to Wi-Fi transmissions.

Step 1006 includes determining an allocation of channel resources reserved for defined transmissions from the at least one sensing transmitter to the at least one sensing receiver according to the sensing goal. According to an implementation, sensing agent 518 on sensing device 506 may be configured to determine the allocation of channel resources reserved for defined transmissions from the at least one sensing transmitter to the at least one sensing receiver according to the sensing goal.

Step 1008 includes causing the defined transmissions from the at least one sensing transmitter to the at least one sensing receiver according to the allocation of channel resources. According to an implementation, sensing agent 518 on sensing device 506 may be configured to cause the defined transmissions from the at least one sensing transmitter to the at least one sensing receiver according to the allocation of channel resources. In an implementation, sensing agent 518 on sensing device 506 may cause the defined transmissions from the at least one sensing transmitter to the at least one sensing receiver by transmission of a sensing trigger message to the at least one sensing transmitter. In an implementation, sensing agent 518 on sensing device 506 may cause the defined transmissions from the at least one sensing transmitter to the at least one sensing receiver by transmission of the defined transmission by the at least one sensing transmitter.

FIG. 11 depicts flowchart 1100 for transmitting a sensing goal to sensing agent 518 on sensing device 506, according to some embodiments.

In a brief overview of an implementation of flowchart 1100, at step 1102, user defined sensing requirements are received. At step 1104, the user defined sensing requirements are translated into a sensing goal. At step 1106, the sensing goal is transmitted to sensing agent 518 on sensing device 506.

Step 1102 includes receiving user defined sensing requirements. According to an implementation, sensing application 508 may be configured to receive the user defined sensing requirements.

Step 1104 includes translating the user defined sensing requirements into a sensing goal. According to an implementation, sensing application 508 may be configured to translate the user defined sensing requirements into the sensing goal.

Step 1106 includes transmitting the sensing goal to sensing agent 518 on sensing device 506. According to an implementation, sensing application 508 may be configured to transmit the sensing goal to sensing agent 518 on sensing device 506.

FIG. 12 depicts another flowchart 1200 for transmitting a sensing goal to sensing agent 518 on sensing device 506, according to some embodiments.

In a brief overview of an implementation of flowchart 1200, at step 1202, algorithmically defined sensing requirements are received. At step 1204, the algorithmically defined sensing requirements are translated into a sensing goal. At step 1206, the sensing goal is transmitted to sensing agent 518 on sensing device 506.

Step 1202 includes receiving algorithmically defined sensing requirements. According to an implementation, sensing application 508 may be configured to receive the algorithmically defined sensing requirements.

Step 1204 includes translating the algorithmically defined sensing requirements into a sensing goal. According to an implementation, sensing application 508 may be configured to translate the algorithmically defined sensing requirements into a sensing goal.

Step 1206 includes transmitting the sensing goal to sensing agent 518 on sensing device 506. According to an implementation, sensing application 508 may be configured to transmit the sensing goal to sensing agent 518 on sensing device 506.

FIG. 13A and FIG. 13B depict another flowchart 1300 for causing defined transmissions from at least one sensing transmitter to at least one sensing receiver according to allocation of channel resources, according to some embodiments.

In a brief overview of an implementation of flowchart 1300, at step 1302, a sensing goal is received. At step 1304, at least one sensing transmitter and at least one sensing receiver are selected according to the sensing goal. At step 1306, an allocation of channel resources reserved for defined transmissions from the at least one sensing transmitter to the at least one sensing receiver are determined according to the sensing goal. At step 1308, timing of the defined transmissions is determined based on the sensing goal, wherein the timing includes at least one of a frequency and a time-criticality. At step 1310, a required precision of the defined transmissions is determined based on the sensing goal. At step 1312, causing the defined transmissions from the at least one sensing transmitter to the at least one sensing receiver according to the allocation of channel resources, the timing of the detailed transmissions, and the required precision of the defined transmissions.

Step 1302 includes receiving a sensing goal. According to an implementation, sensing agent 518 on sensing device 506 may be configured to receive the sensing goal

Step 1304 includes selecting at least one sensing transmitter and at least one sensing receiver according to the sensing goal. According to an implementation, sensing agent 518 on sensing device 506 may be configured to select the at least one sensing transmitter and the at least one sensing receiver according to the sensing goal.

Step 1306 includes determining an allocation of channel resources reserved for defined transmissions from the at least one sensing transmitter to the at least one sensing receiver according to the sensing goal. According to an implementation, sensing agent 518 on sensing device 506 may be configured to determine the allocation of channel resources reserved for the defined transmissions from the at least one sensing transmitter to the at least one sensing receiver according to the sensing goal.

Step 1308 includes determining timing of the defined transmissions based on the sensing goal, wherein the timing includes at least one of a frequency and a time-criticality. According to an implementation, sensing agent 518 on sensing device 506 may be configured to determine the timing of the defined transmissions based on the sensing goal, wherein the timing includes the at least one of the frequency and the time-criticality.

Step 1310 includes determining a required precision of the defined transmissions based on the sensing goal. According to an implementation, sensing agent 518 on sensing device 506 may be configured to determine the required precision of the defined transmissions based on the sensing goal.

Step 1312 includes causing the defined transmissions from the at least one sensing transmitter to the at least one sensing receiver according to the allocation of channel resources, the timing of the detailed transmissions, and the required precision of the defined transmissions. According to an implementation, sensing agent 518 on sensing device 506 may be configured to cause the defined transmissions from the at least one sensing transmitter to the at least one sensing receiver according to the allocation of channel resources, the timing of the detailed transmissions, and the required precision of the defined transmissions.

FIG. 14 depicts flowchart 1400 for transitioning of sensing agent 518 on sensing device 506 from a background detection mode to a sensing goal operating mode in response to detecting an activity, according to some embodiments.

In a brief overview of an implementation of flowchart 1400, at step 1402, a sensing goal is received. At step 1404, a background detection mode is operated. At step 1406, an activity within the background detection mode is detected via Wi-Fi sensing. At step 1408, the background detection mode is transitioned to a sensing goal operating mode in response to detecting the activity, where the sensing goal operating mode includes selecting at least one sensing transmitter and at least one sensing receiver and determine the allocation of channel resources.

Step 1402 includes receiving a sensing goal. According to an implementation, sensing agent 518 on sensing device 506 may be configured to receive the sensing goal.

Step 1404 includes operating a background detection mode. According to an implementation, sensing agent 518 on sensing device 506 may be configured to operate the background detection mode.

Step 1406 includes detecting, within the background detection mode, an activity via Wi-Fi sensing. According to an implementation, sensing agent 518 on sensing device 506 may be configured to detect, within the background detection mode, the activity via the Wi-Fi sensing.

Step 1408 includes transitioning to a sensing goal operating mode in response to detecting the activity, where the sensing goal operating mode includes selecting at least one sensing transmitter and at least one sensing receiver and determining the allocation of channel resources. According to an implementation, sensing agent 518 on sensing device 506 may be configured to transition to the sensing goal operating mode in response to detecting the activity, where the sensing goal operating mode includes selecting the at least one sensing transmitter and the at least one sensing receiver, and determining the allocation of channel resources.

FIG. 15 depicts flowchart 1500 for causing both defined transmissions and second defined transmissions from at least one sensing transmitter to at least one sensing receiver according to allocation of channel resources, according to some embodiments.

In a brief overview of an implementation of flowchart 1500, at step 1502, a second sensing goal is received. At step 1504, a second at least one sensing transmitter and a second at least one sensing receiver are selected according to the second sensing goal. At step 1506, a second allocation of channel resources reserved for second defined transmissions from the second at least one sensing transmitter to the second at least one sensing receiver is determined according to the second sensing goal. At step 1508, both the defined transmissions and the second defined transmissions are caused.

Step 1502 includes receiving a second sensing goal. According to an implementation, sensing agent 518 on sensing device 506 may be configured to receive the second sensing goal.

Step 1504 includes selecting a second at least one sensing transmitter and a second at least one sensing receiver according to the second sensing goal. According to an implementation, sensing agent 518 on sensing device 506 may be configured to select the second at least one sensing transmitter and the second at least one sensing receiver according to the second sensing goal.

Step 1506 includes determining a second allocation of channel resources reserved for second defined transmissions from the second at least one sensing transmitter to the second at least one sensing receiver according to the second sensing goal. According to an implementation, sensing agent 518 on sensing device 506 may be configured to determine the second allocation of channel resources reserved for the second defined transmissions from the second at least one sensing transmitter to the second at least one sensing receiver according to the second sensing goal.

Step 1508 includes causing both the defined transmissions and the second defined transmissions. According to an implementation, sensing agent 518 on sensing device 506 may be configured to cause both the defined transmissions and the second defined transmissions.

FIG. 16 depicts flowchart 1600 for selecting a second at least one sensing transmitter and a second at least one sensing receiver according to a second sensing goal, according to some embodiments.

In a brief overview of an implementation of flowchart 1600, at step 1602, a second sensing goal is received. At step 1604, at least one sensing result is received based on defined transmissions. At step 1606, responsive to the at least one sensing result, a second at least one sensing transmitter and a second at least one sensing receiver are selected according to the second sensing goal and a second allocation of channel resources reserved for second defined transmissions from the second at least one sensing transmitter and the second at least one sensing receiver is determined according to the second sensing goal.

Step 1602 includes receiving a second sensing goal. According to an implementation, sensing agent 518 on sensing device 506 may be configured to receive the second sensing goal.

Step 1604 includes receiving at least one sensing result based on defined transmissions. According to an implementation, sensing agent 518 on sensing device 506 may be configured to receive the at least one sensing result based on the defined transmissions.

Step 1606 includes responsive to the at least one sensing result, selecting a second at least one sensing transmitter and a second at least one sensing receiver according to the second sensing goal and determining a second allocation of channel resources reserved for second defined transmissions from the second at least one sensing transmitter and the second at least one sensing receiver according to the second sensing goal. According to an implementation, responsive to the at least one sensing result, sensing agent 518 on sensing device 506 may be configured to select the second at least one sensing transmitter and the second at least one sensing receiver according to the second sensing goal. Further, sensing agent 518 on sensing device 506 may be configured to determine the second allocation of channel resources reserved for the second defined transmissions from the second at least one sensing transmitter and the second at least one sensing receiver according to the second sensing goal.

Embodiment 1 is a method for Wi-Fi sensing carried out by a sensing device including at least one processor configured to execute instructions. The method comprises receiving, by the at least one processor, a sensing goal; selecting, by the at least one processor, at least one sensing transmitter and at least one sensing receiver according to the sensing goal; determining, by the at least one processor, an allocation of channel resources reserved for defined transmissions from the at least one sensing transmitter to the at least one sensing receiver according to the sensing goal; and causing, by the at least one processor, the defined transmissions from the at least one sensing transmitter to the at least one sensing receiver according to the allocation of channel resources.

Embodiment 2 is the method of embodiment 1, wherein causing the defined transmissions includes causing, by the at least one processor, transmission of a sensing trigger message to the at least one sensing transmitter to cause the defined transmissions.

Embodiment 3 is the method of embodiment 1 or 2, wherein causing the defined transmissions includes causing, by the at least one processor, transmission of the defined transmission by the at least one sensing transmitter.

Embodiment 4 is the method of any of embodiments 1-3, further comprising: receiving, by a sensing application, user defined sensing requirements; and translating, by the sensing application, the user defined sensing requirements into the sensing goal, wherein the at least one processor receives the sensing goal from the sensing application.

Embodiment 5 is the method of any of embodiments 1-4, further comprising: receiving, by a sensing application, algorithmically defined sensing requirements; and translating, by a sensing application, the algorithmically defined sensing requirements into a sensing goal, wherein the at least one processor receives the sensing goal from the sensing application.

Embodiment 6 is the method of any of embodiments 1-5, wherein selecting the at least one sensing transmitter and the at least one sensing receiver is performed based on at least one first location of the at least one sensing transmitter and at least one second location of the at least one sensing receiver.

Embodiment 7 is the method of embodiment 6, wherein the at least one first location or the at least one second location is determined during a device registration process.

Embodiment 8 is the method of embodiment 6 or 7, wherein the at least one first location or the at least one second location is determined according to Wi-Fi transmissions.

Embodiment 9 is the method of any of embodiments 1-8, wherein the selecting the at least one sensing transmitter and the at least one sensing receiver is performed based on a capability of the at least one sensing transmitter or the at least one sensing receiver.

Embodiment 10 is the method of any of embodiments 1-9, wherein the selecting the at least one sensing transmitter and the at least one sensing receiver is performed based on a transmission capacity of the at least one sensing transmitter or the at least one sensing receiver.

Embodiment 11 is the method of any of embodiments 1-10, wherein the selecting the at least one sensing transmitter and the at least one sensing receiver is performed based on a measure of success in achieving the sensing goal by a previously selected sensing transmitter and a previously selected sensing receiver.

Embodiment 12 is the method of any of embodiments 1-11, further comprising: operating, by the at least one processor and prior to selecting the at least one sensing transmitter and the at least one sensing receiver, a background detection mode; detecting, within the background detection mode, activity via Wi-Fi sensing; and transitioning to a sensing goal operating mode in response to detecting activity, wherein the sensing goal operating mode includes selecting the at least one sensing transmitter and the at least one sensing receiver and determining the allocation of channel resources.

Embodiment 13 is the method of any of embodiments 1-12, the method further comprising: receiving, by the at least one processor, a second sensing goal; receiving, by the at least one processor, at least one sensing result based on the defined transmissions; and responsive to the at least one sensing result: selecting a second at least one sensing transmitter and a second at least one sensing receiver according to the second sensing goal; and determining a second allocation of channel resources reserved for second defined transmissions from the second at least one sensing transmitter and the second at least one sensing receiver according to the second sensing goal.

Embodiment 14 is the method of any of embodiments 1-13, further comprising: receiving a second sensing goal; selecting a second at least one sensing transmitter and a second at least one sensing receiver according to the second sensing goal; determining a second allocation of channel resources reserved for second defined transmissions from the second at least one sensing transmitter to the second at least one sensing receiver according to the second sensing goal; and causing, by the at least one processor, both the defined transmissions and the second defined transmissions.

Embodiment 15 is the method of any of embodiments 1-14, further comprising: operating, by the at least one processor and prior to selecting the at least one sensing transmitter and the at least one sensing receiver, a background detection mode, wherein selecting the at least one sensing transmitter and the at least one sensing receiver is performed according to sensing measurements received by the at least one processor while operating in the background detection mode.

Embodiment 16 is the method of any of embodiments 1-15, wherein the sensing goal is defined by at least one of: target type; sensing location; detection mode; time sensitivity; and priority.

Embodiment 17 is the method of any of embodiments 1-16, further comprising determining timing of the defined transmissions based on the sensing goal, wherein timing includes at least one of a frequency and a time-criticality.

Embodiment 18 is the method of any of embodiments 1-17, further comprising determining a required precision of the defined transmissions based on the sensing goal.

Embodiment 19 is the method of any of embodiments 1-18, wherein determining the allocation of channel resources includes determining one or more bandwidths reserved for the defined transmissions from the at least one sensing transmitter.

Embodiment 20 is the method of embodiment 19, wherein the one or more bandwidths are one or more channel bandwidths.

Embodiment 21 is the method of any of embodiments 1-20, wherein determining the allocation of channel resources includes determining one or more resource units reserved for the defined transmissions from the at least one sensing transmitter.

Embodiment 22 is a system for Wi-Fi sensing. The system comprises a sensing device including at least one processor configured to execute instructions for receiving a sensing goal; selecting at least one sensing transmitter and at least one sensing receiver according to the sensing goal; determining an allocation of channel resources reserved for defined transmissions from the at least one sensing transmitter to the at least one sensing receiver according to the sensing goal; and causing the defined transmissions from the at least one sensing transmitter to the at least one sensing receiver according to the allocation of channel resources.

Embodiment 23 is the system of embodiment 22, wherein causing the defined transmissions is performed by causing, transmission of a sensing trigger message to the at least one sensing transmitter to cause the defined transmissions.

Embodiment 24 is the system of embodiment 22 or 23, wherein causing the defined transmissions is performed by causing transmission of the defined transmission by the at least one sensing transmitter.

Embodiment 25 is the system of any of embodiments 22-24, wherein the at least one processor is further configured to execute instructions for: receiving user defined sensing requirements; and translating the user defined sensing requirements into the sensing goal, wherein the at least one processor receives the sensing goal from the sensing application.

Embodiment 26 is the system of any of embodiments 22-25, wherein the at least one processor is further configured to execute instructions for: receiving algorithmically defined sensing requirements; and translating the algorithmically defined sensing requirements into a sensing goal, wherein the at least one processor receives the sensing goal from the sensing application.

Embodiment 27 is the system of any of embodiments 22-26, wherein selecting the at least one sensing transmitter and the at least one sensing receiver is performed based on at least one first location of the at least one sensing transmitter and at least one second location of the at least one sensing receiver.

Embodiment 28 is the system of any of embodiments 22-27, wherein the at least one first location or the at least one second location is determined during a device registration process.

Embodiment 29 is the system of embodiment 28, wherein the at least one first location or the at least one second location is determined according to Wi-Fi transmissions.

Embodiment 30 is the system of any of embodiments 22-29, wherein selecting the at least one sensing transmitter and the at least one sensing receiver is performed based on a capability of the at least one sensing transmitter or the at least one sensing receiver.

Embodiment 31 is the system of any of embodiments 22-30, wherein selecting the at least one sensing transmitter and the at least one sensing receiver is performed based on a transmission capacity of the at least one sensing transmitter or the at least one sensing receiver.

Embodiment 32 is the system of any of embodiments 22-31, wherein selecting the at least one sensing transmitter and the at least one sensing receiver is performed based on a measure of success in achieving the sensing goal by a previously selected sensing transmitter and a previously selected sensing receiver.

Embodiment 33 is the system of any of embodiments 22-32, wherein the at least one processor is further configured to execute instructions for: operating, prior to selecting the at least one sensing transmitter and the at least one sensing receiver, a background detection mode; detecting, within the background detection mode, activity via Wi-Fi sensing; and transitioning to a sensing goal operating mode in response to detecting activity, wherein the sensing goal operating mode includes selecting the at least one sensing transmitter and the at least one sensing receiver and determining the allocation of channel resources.

Embodiment 34 is the system of any of embodiments 22-33, wherein the at least one processor is further configured to execute instructions for: receiving a second sensing goal; receiving at least one sensing result based on the defined transmissions; and responsive to the at least one sensing result: selecting a second at least one sensing transmitter and a second at least one sensing receiver according to the second sensing goal; and determining a second allocation of channel resources reserved for second defined transmissions from the second at least one sensing transmitter and the second at least one sensing receiver according to the second sensing goal.

Embodiment 35 is the system of any of embodiments 22-34, wherein the at least one processor is further configured to execute instructions for: receiving a second sensing goal; selecting a second at least one sensing transmitter and a second at least one sensing receiver according to the second sensing goal; determining a second allocation of channel resources reserved for second defined transmissions from the second at least one sensing transmitter to the second at least one sensing receiver according to the second sensing goal; and causing, by the at least one processor, both the defined transmissions and the second defined transmissions.

Embodiment 36 is the system of any of embodiments 22-35, wherein the at least one processor is further configured to execute instructions for: operating, prior to selecting the at least one sensing transmitter and the at least one sensing receiver, a background detection mode, wherein selecting the at least one sensing transmitter and the at least one sensing receiver is performed according to sensing measurements received by the at least one processor while operating in the background detection mode.

Embodiment 37 is the system of any of embodiments 22-36, wherein the sensing goal is defined by at least one of: target type; sensing location; detection mode; time sensitivity; and priority.

Embodiment 38 is the system of any of embodiments 22-37, wherein the at least one processor is further configured to execute instructions for determining timing of the defined transmissions based on the sensing goal, wherein timing includes at least one of a frequency and a time-criticality.

Embodiment 39 is the system of any of embodiments 22-38, wherein the at least one processor is further configured to execute instructions for determining a required precision of the defined transmissions based on the sensing goal.

Embodiment 40 is the system of any of embodiments 22-38, wherein determining the allocation of channel resources includes determining one or more bandwidths reserved for the defined transmissions from the at least one sensing transmitter.

Embodiment 41 is the system of embodiment 40, wherein the one or more bandwidths are one or more channel bandwidths.

Embodiment 42 is the system of any of embodiments 22-41, wherein determining the allocation of channel resources includes determining one or more resource units reserved for the defined transmissions from the at least one sensing transmitter. While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method for Wi-Fi sensing carried out by a sensing device including at least one processor configured to execute instructions, the method comprising:
receiving, by the at least one processor, a sensing goal;
selecting, by the at least one processor, at least one sensing transmitter and at least one sensing receiver according to the sensing goal;
determining, by the at least one processor, an allocation of channel resources reserved for defined transmissions from the at least one sensing transmitter to the at least one sensing receiver according to the sensing goal; and
causing, by the at least one processor, transmission of the defined transmissions from the at least one sensing transmitter to the at least one sensing receiver according to the allocation of channel resources.

2. The method of claim 1, wherein causing the transmission of the defined transmissions includes causing, by the at least one processor, transmission of a sensing trigger message to the at least one sensing transmitter to cause the defined transmissions.

3. (canceled)

4. The method of claim 1, further comprising:
receiving, by a sensing application, user defined sensing requirements; and
translating, by the sensing application, the user defined sensing requirements into the sensing goal, wherein the at least one processor receives the sensing goal from the sensing application.

5. The method of claim 1, further comprising:
receiving, by a sensing application, algorithmically defined sensing requirements; and
translating, by a sensing application, the algorithmically defined sensing requirements into a sensing goal, wherein the at least one processor receives the sensing goal from the sensing application.

6. The method of claim 1, wherein selecting the at least one sensing transmitter and the at least one sensing receiver is performed based on at least one first location of the at least one sensing transmitter and at least one second location of the at least one sensing receiver.

7. (canceled)

8. (canceled)

9. The method of claim 1, wherein the selecting the at least one sensing transmitter and the at least one sensing receiver is performed based on a capability of the at least one sensing transmitter or the at least one sensing receiver.

10. (canceled)

11. The method of claim 1, wherein the selecting the at least one sensing transmitter and the at least one sensing receiver is performed based on a measure of success in achieving the sensing goal by a previously selected sensing transmitter and a previously selected sensing receiver.

12. The method of claim 1, further comprising:
operating, by the at least one processor and prior to selecting the at least one sensing transmitter and the at least one sensing receiver, a background detection mode;
detecting, within the background detection mode, activity via Wi-Fi sensing; and
transitioning to a sensing goal operating mode in response to detecting activity, wherein the sensing goal operating mode includes selecting the at least one sensing transmitter and the at least one sensing receiver and determining the allocation of channel resources.

13. The method of claim 1, the method further comprising:
receiving, by the at least one processor, a second sensing goal;
receiving, by the at least one processor, at least one sensing result based on the defined transmissions; and
responsive to the at least one sensing result:
selecting a second at least one sensing transmitter and a second at least one sensing receiver according to the second sensing goal; and
determining a second allocation of channel resources reserved for second defined transmissions transmitted from the second at least one sensing transmitter and received by the second at least one sensing receiver according to the second sensing goal.

14. The method of claim 1, further comprising:
receiving a second sensing goal;
selecting a second at least one sensing transmitter and a second at least one sensing receiver according to the second sensing goal;
determining a second allocation of channel resources reserved for second defined transmissions transmitted from the second at least one sensing transmitter to the second at least one sensing receiver according to the second sensing goal; and
causing, by the at least one processor, the transmission of the defined transmissions and transmission of the second defined transmissions.

15. The method of claim 1, further comprising:
operating, by the at least one processor and prior to selecting the at least one sensing transmitter and the at least one sensing receiver, a background detection mode,
wherein selecting the at least one sensing transmitter and the at least one sensing receiver is performed according to sensing measurements received by the at least one processor while operating in the background detection mode.

16. The method of claim 1, wherein the sensing goal is defined by at least one of:
target type;
sensing location;
detection mode;
time sensitivity; and
priority.

17. The method of claim 1, further comprising determining timing of the transmission of the defined transmissions based on the sensing goal, wherein timing includes at least one of a frequency of transmission of one or more of the defined transmissions and a time-criticality of transmission of one or more of the defined transmissions.

18. The method of claim 1, further comprising determining the defined transmissions based on a required precision of the sensing goal.

19. (canceled)

20. (canceled)

21. (canceled)

22. A system for Wi-Fi sensing, comprising:
a sensing device including at least one processor configured to execute instructions for:
receiving a sensing goal;
selecting at least one sensing transmitter and at least one sensing receiver according to the sensing goal;
determining an allocation of channel resources reserved for defined transmissions from the at least one sensing transmitter to the at least one sensing receiver according to the sensing goal; and
causing transmission of the defined transmissions from the at least one sensing transmitter to the at least one sensing receiver according to the allocation of channel resources.

23. (canceled)

24. (canceled)

25. The system of claim 22, wherein the at least one processor is further configured to execute instructions for:
receiving user defined sensing requirements; and
translating the user defined sensing requirements into the sensing goal, wherein the at least one processor receives the sensing goal from a sensing application.

26. (canceled)

27. The system of claim 22, wherein selecting the at least one sensing transmitter and the at least one sensing receiver is performed based on at least one first location of the at least one sensing transmitter and at least one second location of the at least one sensing receiver.

28. (canceled)

29. (canceled)

30. (canceled)

31. (canceled)

32. (canceled)

33. (canceled)

34. (canceled)

35. The system of claim 22, wherein the at least one processor is further configured to execute instructions for:
receiving a second sensing goal;
selecting a second at least one sensing transmitter and a second at least one sensing receiver according to the second sensing goal;
determining a second allocation of channel resources reserved for second defined transmissions from the second at least one sensing transmitter to the second at least one sensing receiver according to the second sensing goal; and
causing, by the at least one processor, the transmission of the defined transmissions and transmission of the second defined transmissions.

36. The system of claim 22, wherein the at least one processor is further configured to execute instructions for:
operating, prior to selecting the at least one sensing transmitter and the at least one sensing receiver, a background detection mode,
wherein selecting the at least one sensing transmitter and the at least one sensing receiver is performed according to sensing measurements received by the at least one processor while operating in the background detection mode.

37. The system of claim 22, wherein the sensing goal is defined by at least one of:
target type;
sensing location;
detection mode;
time sensitivity; and
priority.

38. (canceled)

39. (canceled)

40. (canceled)

41. (canceled)

42. (canceled)
